(19) United States
(12) Patent Application Publication
(10) Pub. No.: US 2012/0288006 A1
(43) Pub. Date: Nov. 15, 2012

(54) APPARATUS AND METHOD FOR IMAGE PROCESSING

(76) Inventor: Kazushi Sato, Kanagawa (JP)

(21) Appl. No.: 13/521,730

(22) PCT Filed: Jan. 14, 2011
(86) PCT No.: PCT/JP2011/050494

§ 371 Date: Jul. 11, 2012

(30) Foreign Application Priority Data
Jan. 22, 2010 (JP) 20100212515

(51) Int. Cl. H04N 7/32

(52) U.S. Cl. 375/240.16; 375/E07.243

(57) ABSTRACT

The present invention relates to an apparatus and method for image processing allows for achievement of improved prediction efficiency in weighted prediction of chrominance signals. Upon receiving reference image pixel values referred to by motion vector information from a motion compensator (82), a luminance weighted motion compensator (96) uses weight factors and offset values from a luminance weight/offset calculator (94) to perform weighted prediction processing on luminance signals and chrominance signals (in case of RGB). Upon receiving reference image pixel values referred to by motion vector information from the motion compensator (82), a chrominance weighted motion compensator (97) uses weight factors and offset values from a chrominance weight/offset calculator (95) to perform weighted prediction processing on chrominance signals (in case of YCbCr). The present invention is applicable to, for example, an image coding apparatus for performing encoding based on H.264/AVC standard.

### TECHNICAL FIELD

The present invention relates to apparatuses and methods for image processing, and more particularly, to apparatuses and methods for image processing with improved prediction efficiency in weighted prediction for chrominance signals.

### BACKGROUND ART

Recently, apparatuses have been spreading which are configured to digitally handle image information while, in order to transmit and accumulate information with higher efficiency, compressing and encoding images by adopting a coding standard for performing compression through orthogonal transformation, such as discrete cosine transform, and motion compensation with the use of redundancy unique to image information. Exemplary coding standards include MPEG (Moving Picture Expert Group).

To be noted here, MPEG-2 (ISO/IEC 13818-2) is defined as a general-purpose image coding standard that covers both interlaced scan images and progressive scan images, as well as standard resolution images and high definition images. For example, MPEG-2 is currently in wide use for a variety of applications for professional use and consumer use. By the use of MPEG-2 compression standard, a bit rate of 4 to 8 Mbps is assigned to, for example, an interlaced scan image of a standard resolution with 720×480 pixels. Further, by the use of MPEG-2 compression standard, a bit rate of 18 to 22 Mbps is assigned to, for example, an interlaced scan image of a high resolution with 1920×1088 pixels. This allows for achievement of a higher compression rate and a better image quality.

MPEG-2 is mainly for high image quality coding adapted for broadcasting; however, this standard is not compatible with coding standards that involve bit rates that are lower than MPEG-1, i.e., higher compression rates. It is expected that the spread of mobile terminals would increase the need for such a coding standard from now on, and in response to such a movement, standardization of MPEG-4 coding standard has been carried out. Regarding image coding standards, ISO/MC 14496-2 was agreed upon as an international standard in December, 1998.

Recently, standardization of a standard referred to as H.26L (ITU-T Q6/16 VCEG) is under progress aiming for image coding, which was initially for video conference. While H.26L entails larger amounts of arithmetic operation in encoding and decoding as compared with a coding standard used up to now, such as MPEG-2 and MPEG-4, it is known that higher coding efficiency is achievable. As a current activity related to MPEG-4, standardization is attempted as Joint Model of Enhanced-Compression Video Coding based on H.26L, so as to achieve higher coding efficiency with additional functions that are not supported by H.26L. The standardization is scheduled to be developed into an international standard as H.264 and MPEG-4 Part 10 in March, 2003 (Advanced Video Coding; hereinafter referred to as H.264/AVC).

As an extended activity, standardization has been completed in February, 2005 as FRExt (Fidelity Range Extension) that encompasses coding tools for business use, such as RGB and 4:2:2 and 4:4:4, and 8×8 DCT and quantization matrices that are defined by MPEG-2. This fructifies into a coding standard achieving favorable rendering of even film noise contained in movies with the use of H.264/AVC, which is going to be used in a wide range of applications including Blu-Ray Disc (trademark).

Meanwhile, needs are growing nowadays for coding technologies allowing for higher compression rates which will, for example, enable compression of an image on the order of 4000×2000 that is as four times finer as high definition images or distribution of high definition images in an environment where transmission capacity is limited, as over the Internet. For this reason, study is continuously conducted on improvement of coding efficiency at VCEG (=Video Coding Expert Group) which is a subgroup of the above-mentioned ITU-T.

Consider a sequence, such as fade-in/fade-out scenes, in which brightness changes; according to MPEG-2 or MPEG-4 standards, a coding tool to absorb changes in brightness is not provided, which may lead to lowering of coding efficiency.

Meanwhile, weighted prediction processing as also proposed in Non-patent Document 1 is possible according to H.264/AVC standard.

In the weighted prediction processing of P pictures, where Y₀ is the motion-compensating prediction signal (the reference image pixel value), W₀ is the weight factor, and D is the offset value, prediction signals are generated according to the following equation (1):

Prediction signal=W₀*Y₀+D (1)

For B pictures, where Y₀ and Y₁ are the motion-compensating prediction signals and W₀ and W₁ are the weight factors for the signals for List0 and List1, respectively, and D is the offset value, prediction signals are generated according to the following equation (2):

Prediction signal=W₀*Y₀+W₁*Y₁+D (2)

According to H.264/AVC standard, whether or not the weighted prediction is used may be specified in the unit of slices.

In the weighted prediction according to H.264/AVC standard, Explicit Mode and Implicit Mode are defined for the slice header. In Explicit Mode, W and D are added for transmission, whereas in Implicit Mode, W is calculated based on the distance on the time axis between the relevant picture and its reference picture.

Of the two modes, Explicit Mode is used for P pictures, whereas both Explicit Mode and Implicit Mode may be used for B pictures.

In performing image compression of color image signals, RGB signals are converted to the luminance signal Y and the chrominance signals Cb and Cr according to the following equation (3), so as to perform the subsequent processing:

Y=0.299R+0.587G+0.114B

Cb=−0.169R−0.331G+0.500B

Cr=0.500R−0.419G−0.081B (3)

Herein, the luminance signal Y is a component representing brightness, and the value thereof falls within a range of 0 to 1. In the case of eight bit representation, the value is in a range of 0 to 255.

Meanwhile, the chrominance signals Cb and Cr are components representing the intensity and kinds of colors, and the values thereof fall within a range of −0.5 to 0.5. In the case of eight bit representation, the values are in a range of 0 to 255 centering 128.

In comparison with the luminance signal, the chrominance signals are generally lower in resolution; thus, a format involving a lower resolution as compared with the luminance signal is used for the chrominance signals in image compression, such as 4:2:2 or 4:2:0.

According to H.264/AVC standard, the macroblock size is 16×16 pixels. Setting the macroblock size to 16×16 pixels however is not optimal for larger picture frames such as UHD (Ultra High Definition; 4000×2000 pixels) which can be an object of next-generation coding standards.

Thus, in documents such as Non-patent Document 2, proposal is made to extend the macroblock size to, for example, 32×32 pixels.

### CITATION LIST

### Non-Patent Document

Non-patent Document 1: “Improved multiple frame motion compensation using frame interpolation” JVT-B075, January 2002
Non-patent Document 2: “Video Coding Using Extended Block Sizes”, VCEG-AD09, ITU-Telecommunications Standardization Sector STUDY GROUP Question 16—Contribution 123, January 2009

### SUMMARY OF THE INVENTION

### Problems to be Solved by the Invention

As described above, in eight-bit image signals, a luminance signal of 128 denotes 0.5, while a chrominance signal of 128 indicates 0. In the weighted prediction according to H.264/AVC standard however, similar processing is performed both on luminance signals and chrominance signals. Hence, prediction efficiency may be lower in some cases for chrominance signals as compared with luminance signals.

The present invention was made in view of the foregoing circumstances and achieves improved prediction efficiency in the weighted prediction of chrominance signals.

### Solutions to Problems

An image processing apparatus according to a first aspect of the present invention includes: motion search means for searching a motion vector for a block to be encoded in an image; and weighted prediction means for, in case where the image has a color format of YCbCr format, using a reference image pixel value referred to by the motion vector to be found through the search by the motion search means and performing weighted prediction differently on a chrominance component than on a luminance component.

In case where the color format of the image is YCbCr format, factor calculation means for calculating a weight factor and an offset for the chrominance component is further provided, and the weighted prediction means may be configured to use the weight factor and the offset to be calculated by the factor calculation means and the reference image pixel value to perform weighted prediction differently on the chrominance component than on the luminance component.

The weighted prediction means may be configured to perform weighted prediction on the chrominance component according to the input bit accuracy and picture type of the image.

In case of a P picture, the weighted prediction means may be configured to perform weighted prediction representable by W₀*(Y₀−2ⁿ⁻¹)+D+2ⁿ⁻¹ where, with the input being a video represented in n bit, Y₀ is the reference image pixel value, and W₀ and D are the weight factor and the offset for the weighted prediction, respectively, with respect to the chrominance component.

In case of a B picture, the weighted prediction means may be configured to perform weighted prediction representable by W₀*(Y₀−2ⁿ⁻¹)+W₁*(Y₁−2ⁿ⁻¹)D+2ⁿ⁻¹ where, with the input being a video represented in n bit, Y₀ and Y₁ are the reference image pixel values in List0 and List1, respectively, and W₀, W₁, and D are the weight factors for List0 and List1 and the offset for the weighted prediction, respectively, with respect to the chrominance component.

In case where the color format of the image is RGB format, the reference image pixel value may be for use in performing the same weighted prediction on the chrominance component as that to be performed on the luminance component.

A method of processing images according to a first aspect of the present invention, the method being for use in an image processing apparatus including motion search means and weighted prediction means, includes: performing by the motion search means of the image processing apparatus search for a motion vector for a block to be encoded in an image; and performing by the weighted prediction means of the image processing apparatus, in case where the image has a color format of YCbCr format, weighted prediction on a chrominance component differently than on a luminance component by using a reference image pixel value referred to by the motion vector found through the search.

An image processing apparatus according to a second aspect of the present invention includes: decoding means for decoding a motion vector for a block to be decoded in an encoded image; and weighted prediction means for using, in case where the image has a color format of YCbCr format, a reference image pixel value referred to by the motion vector to be decoded by the decoding means and performing weighted prediction on a chrominance component differently than on a luminance component.

The weighted prediction means may be configured to perform weighted prediction on the chrominance component according to the input bit accuracy and picture type of the image.

In case of a P picture, the weighted prediction means may be configured to perform weighted prediction representable by W₀*(Y₀−2ⁿ⁻¹)+D+2ⁿ⁻¹ where, with the input being a video represented in n bit, Y₀ is the reference image pixel value, and W₀ and D are the weight factor and the offset for the weighted prediction, respectively, with respect to the chrominance component.

In case of a B picture, the weighted prediction means may be configured to perform weighted prediction representable by W₀*(Y₀−2ⁿ⁻¹)+W₁*(Y₁−2ⁿ⁻¹)D+2ⁿ⁻¹ where, with the input being a video represented in n bit, Y₀ and Y₁ are the reference image pixel values in List0 and List1, respectively, and W₀, W₁, and D are the weight factors for List0 and List1 and the offset for the weighted prediction, respectively, with respect to the chrominance component.

In case where the color format of the image is YCbCr format, factor calculation means for calculating a weight factor for the chrominance component is further provided, and the weighted prediction means may be configured to use the weight factor to be calculated by the factor calculation means and the reference image pixel value to perform weighted prediction differently on the chrominance component than on the luminance component.

In case where the color format of the image is YCbCr format, the decoding means may be configured to decode the weight factor and the offset for the chrominance component, and the weighted prediction means may be configured to use the weight factor and the offset to be decoded by the decoding means and the reference image pixel value to perform weighted prediction on the chrominance component differently than on the luminance component.

In case where the color format of the image is RGB format, the reference image pixel value may be for use in performing the same weighted prediction on the chrominance component as that to be performed on the luminance component.

A method for processing images according to a second aspect of the present invention, the method being for use in an image processing apparatus including decoding means and weighted prediction means, includes: performing by the decoding means of the image processing apparatus decoding of a motion vector for a block to be decoded in an encoded image; and performing by the weighted prediction means of the image processing apparatus, in case where the image has a color format of YCbCr format, weighted prediction on a chrominance component differently than on a luminance component by using a reference image pixel value referred to by the decoded motion vector.

According to the first aspect of the present invention, a motion vector for a block to be encoded in an image is searched. In case where the color format of the image is YCbCr format, the reference image pixel value referred to by the motion vector searched is used, such that weighted prediction is performed on a chrominance component differently than on a luminance component.

According to the second aspect of the present invention, a motion vector for a block to be decoded in an encoded image is decoded. In case where the color format of the image is YCbCr format, the reference image pixel value referred to by the decoded motion vector is used, such that weighted prediction is performed differently on chrominance component than on a luminance component.

It is to be noted that the above-described image processing apparatuses may be discrete apparatuses or may be internal blocks configuring one image coding apparatus or image decoding apparatus.

### Effects of the Invention

The present invention achieves improved prediction efficiency in weighted prediction for chrominance signals.

### BRIEF DESCRIPTION OF DRAWINGS

FIG. 1 is a block diagram depicting the configuration of one embodiment of an image coding apparatus to which the present invention is applied.

FIG. 2 is an explanatory diagram of motion prediction/compensation processing at ¼ pixel accuracy.

FIG. 3 is an explanatory diagram of motion prediction/compensation processing in a variable block size.

FIG. 4 is an explanatory diagram of motion prediction/compensation standard for multi reference frames.

FIG. 5 is an explanatory diagram of an example of a method of generating motion vector information.

FIG. 6 is an explanatory diagram of a method of calculating a weight factor and an offset in Implicit Mode.

FIG. 7 is an explanatory diagram of a method of motion search.

FIG. 8 is a block diagram depicting a configuration example of a motion predictor/compensator and a weighted predictor of FIG. 1.

FIG. 9 is a flowchart for describing encoding processing of the image coding apparatus of FIG. 1.

FIG. 10 is a flowchart for describing intra prediction processing in step S21 of FIG. 9.

FIG. 11 is a flowchart for describing inter motion prediction processing in step S22 of FIG. 9.

FIG. 12 is a flowchart for describing weighted prediction processing in step S54 of FIG. 11.

FIG. 13 is a block diagram depicting the configuration of one embodiment of an image decoding apparatus to which the present invention is applied.

FIG. 14 is a block diagram depicting a configuration example of a motion predictor/compensator and a weighted predictor of FIG. 13.

FIG. 15 is a flowchart for describing decoding processing of the image decoding apparatus of FIG. 13.

FIG. 16 is a flowchart for describing prediction processing in step S138 of FIG. 15.

FIG. 17 is a flowchart for describing prediction processing in step S175 of FIG. 16.

FIG. 18 depicts examples of extended macroblocks.

FIG. 19 is a block diagram of a configuration example of hardware of a computer.

FIG. 20 is a block diagram of a main configuration example of a television receiver to which the present invention is applied.

FIG. 21 is a block diagram depicting a main configuration example of a mobile phone to which the present invention is applied.

FIG. 22 is a block diagram depicting a main configuration example of a hard disk recorder to which the present invention is applied.

FIG. 23 is a block diagram depicting a main configuration example of a camera to which the present invention is applied.

FIG. 24 depicts an example of Coding Units defined by HEVC.

### MODE FOR CARRYING OUT THE INVENTION

Embodiments of the present invention are described below with reference to the drawings.

### Configuration Example of Image Coding Apparatus

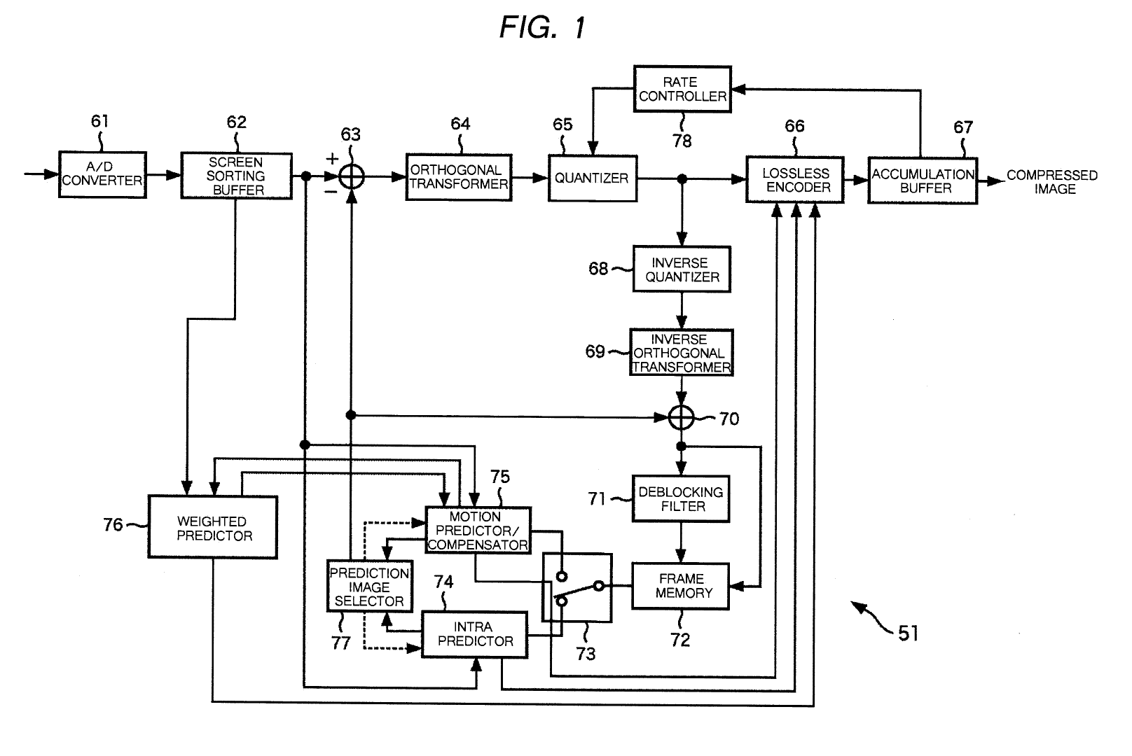

FIG. 1 is a block diagram depicting the configuration of one embodiment of an image coding apparatus to which the present invention is applied.

An image coding apparatus 51 is configured to compress and encode images based on, for example, H.264 and MPEG-4 Part 10 (Advanced Video Coding) (hereinafter referred to as H.264/AVC) standard.

In the example of FIG. 1, the image coding apparatus 51 includes an A/D converter 61, an image sorting buffer 62, an arithmetic operator 63, an orthogonal transformer 64, a quantizer 65, a lossless encoder 66, an accumulation buffer 67, an inverse quantizer 68, an inverse orthogonal transformer 69, an arithmetic operator 70, a deblocking filter 71, a frame memory 72, a switch 73, an intra predictor 74, a motion predictor/compensator 75, a weighted predictor 76, a prediction image selector 77, and a rate controller 78.

The A/D converter 61 performs A/D conversion on inputted images for output to the screen sorting buffer 62 such that the converted images are stored thereon. The screen sorting buffer 62 sorts images of frames in the stored display order into an order of frames for encoding according to GOP (Groups of Pictures).

The arithmetic operator 63 subtracts, from the images read from the screen sorting buffer 62, prediction images that have been outputted either from the intra predictor 74 or from the motion predictor/compensator 75 and been selected by the prediction image selector 77, so as to output the difference information to the orthogonal transformer 64. The orthogonal transformer 64 performs orthogonal transform, such as discrete cosine transform or Karhunen-Loeve transform, on the difference information from the arithmetic operator 63 and outputs the transform coefficients. The quantizer 65 quantizes the transform coefficients outputted from the orthogonal transformer 64.

The quantized transform coefficients, which are the outputs from the quantizer 65, are inputted to the lossless encoder 66 so as to be subjected there to lossless encoding such as variable length coding or binary arithmetic coding, for compression.

The lossless encoder 66 obtains information indicating intra prediction from the intra predictor 74 and obtains, for example, information indicating inter prediction mode from the motion predictor/compensator 75. The information indicating intra prediction and the information indicating inter prediction are also referred to as “intra prediction mode information” and “inter prediction mode information,” respectively.

The lossless encoder 66 encodes the quantized transform coefficients as well as, for example, information indicating intra prediction and information indicating inter prediction mode and includes the encoded information into header information for compressed images. The lossless encoder 66 supplies the encoded data to the accumulation buffer 67 for accumulation.

For example, lossless encoding processing such as variable length coding or binary arithmetic coding is performed at the lossless encoder 66. Examples of the variable length coding include CAVLC (Context-Adaptive Variable Length Coding) defined by H.264/AVC standard. Examples of the binary arithmetic coding include CABAC (Context-Adaptive Binary Arithmetic Coding).

The accumulation buffer 67 outputs data supplied from the lossless encoder 66 to, for example, a recording apparatus or a channel at the later stage (not shown), as encoded compressed images.

The quantized transform coefficients outputted from the quantizer 65 are also inputted to the inverse quantizer 68 to be subjected to inverse quantization, followed by inverse orthogonal transform at the inverse orthogonal transformer 69.

The inverse orthogonal transformed outputs are added by the arithmetic operator 70 to prediction images to be supplied from the prediction image selector 77 so as to constitute a locally decoded image. The deblocking filter 71 removes block distortion in the decoded images to supply the images to the frame memory 72 for accumulation thereon. The frame memory 72 is also supplied with images that are yet to be subjected to deblocking filter processing to be performed by the deblocking filter 71 for accumulation thereon.

The switch 73 outputs the reference image accumulated on the frame memory 72 to the motion predictor/compensator 75 or to the intra predictor 74.

In the image coding apparatus 51, for example, I pictures, B pictures, and P pictures from the screen sorting buffer 62 are supplied to the to the intra predictor 74 as images for intra prediction (also referred to as “intra processing.”) Further, B pictures and P pictures read from the screen sorting buffer 62 are supplied to the motion predictor/compensator 75 as images for inter prediction (also referred to as “inter processing.”)

The intra predictor 74 performs intra prediction processing in all candidate intra prediction modes based on the images to be subjected to intra prediction that are read from the screen sorting buffer 62 and the reference images supplied from the frame memory 72, so as to generate prediction images. At this time, the intra predictor 74 calculates cost function values for all the candidate intra prediction modes and selects as an optimum intra prediction mode an intra prediction mode to which a minimum cost function value is given by the calculation.

The intra predictor 74 supplies the prediction images generated in the optimum intra prediction mode and the cost function values thereof to the prediction image selector 77. The intra predictor 74 supplies, in the case where a prediction image generated in the optimum intra prediction mode is selected by the prediction image selector 77, the information indicating the optimum intra prediction mode to the lossless encoder 66. The lossless encoder 66 encodes the information to include the information into header information for compressed images.

The motion predictor/compensator 75 is supplied with images to be subjected to inter processing that have been read from the screen sorting buffer 62, as well as reference images from the frame memory 72 through the switch 73. The motion predictor/compensator 75 performs motion search (prediction) in all candidate inter prediction modes.

Then, in the case where a control signal indicating that weighted prediction be performed is inputted by the weighted predictor 76, the motion predictor/compensator 75 supplies to the weighted predictor 76 the control signal that weighed prediction be performed and a reference image that the motion vector searched refers to. In the case where a control signal that weighted prediction not be performed is inputted by the weighted predictor 76, the motion predictor/compensator 75 performs compensation processing on a reference image by using the motion vector searched, so as to generate a prediction image.

The motion predictor/compensator 75 calculates cost function values for all the candidate inter prediction modes by using either the prediction images generated or prediction images from the weighted predictor 76. The motion predictor/compensator 75 decides as an optimum inter prediction mode a mode that gives a minimum value of the calculated cost function values, and supplies prediction images generated in the optimum inter prediction mode and the cost function values thereof to the prediction image selector 77. The motion predictor/compensator 75 outputs information indicating the optimum inter prediction mode (inter prediction mode information) to the lossless encoder 66 in the case where a prediction image generated in the optimum inter prediction mode is selected by the prediction image selector 77.

At this time, information including motion vector information and reference frame information is also outputted to the lossless encoder 66. The lossless encoder 66 also performs lossless encoding processing such as variable length coding or binary arithmetic coding on the information from the motion predictor/compensator 75, so as to incorporate the information into the header portions of compressed images.

Images to be subjected to inter processing are inputted to the weighted predictor 76 from the image sorting buffer 62. The weighted predictor 76 determines whether to perform weighted prediction through observation of change in brightness of the images inputted, so as to supply control signals indicating the result of determination to the motion predictor/compensator 75 and discern color formats of the inputted images.

Further, control signals indicating that weighted prediction be performed and reference images referred to by the motion vectors are inputted to the weighted predictor 76 from the motion predictor/compensator 75. Upon receiving a control signal from the motion predictor/compensator 75, the weighted predictor 76 calculates a weight factor and an offset value according to the color format thereof. The weight factors and the offset values are outputted to the lossless encoder 66 as needed.

The weighted predictor 76 performs weighted prediction by using reference images inputted, based on the weight factors and the offset values according to the color formats discerned, so as to generate prediction images. The prediction images generated are supplied to the motion predictor/compensator 75.

The prediction image selector 77 decides an optimum prediction mode from the optimum intra prediction mode and the optimum inter prediction mode based on the cost function values outputted from the intra predictor 74 or the motion predictor/compensator 75. Then, the prediction image selector 77 selects prediction images in the optimum prediction mode decided and supplies the images to the arithmetic operators 63 and 70. At this time, the prediction image selector 77 supplies to the intra predictor 74 or the motion predictor/compensator 75 the information on selection of prediction images.

The rate controller 78 controls the rate of the quantizing operation of the quantizer 65 based on the compressed images accumulated in the accumulation buffer 67 so as to protect from overflow or underflow.

### Description of H.264/AVC Standard

Description is given next of H.264/AVC standard on which the image coding apparatus 51 is based.

For example, according to MPEG-2 standard, motion prediction/compensation processing is performed at ½ pixel accuracy by linear interpolation processing. On the other hand, according to H.264/AVC standard, prediction/compensation processing is performed at ¼ pixel accuracy with a 6-tap FIR (Finite Impulse Response Filter) filter used as an interpolation filter.

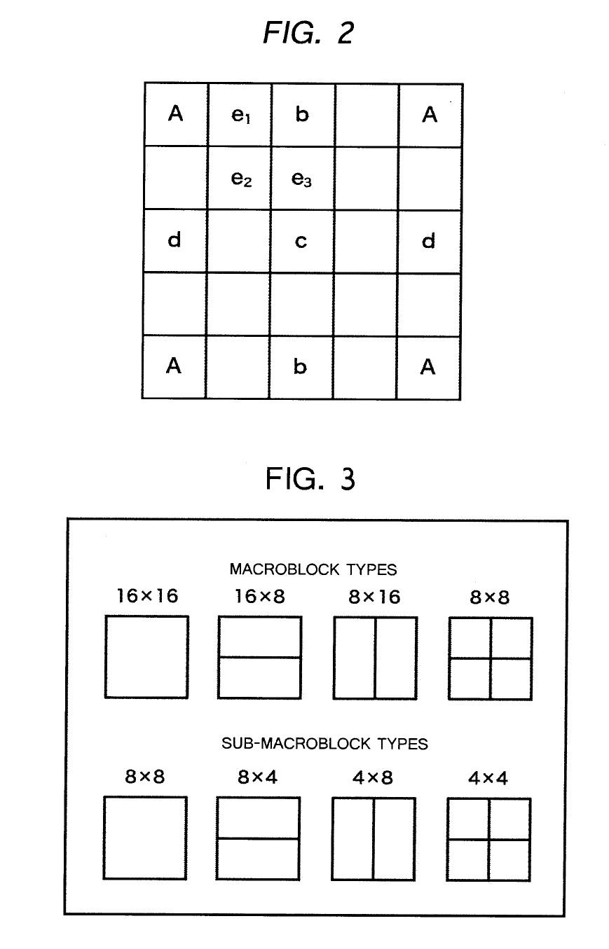

FIG. 2 is an explanatory diagram of prediction/compensation processing at ¼ pixel accuracy according to H.264/AVC standard. According to H.264/AVC standard, prediction/compensation processing is performed at ¼ pixel accuracy by using a 6-tap FIR (Finite Impulse Response Filter) filter.

In the example of FIG. 2, the positions A indicate positions of integer accuracy pixels, the positions b, c, and d indicate ½ pixel accuracy positions, and the positions e1, e2, and e3 indicate ¼ pixel accuracy positions. In the following, Clip( ) is first defined as the following equation (4):

$$\begin{matrix}[ Formula 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 4 )\end{matrix}$$

In the case where the input image is at 8-bit accuracy, max_pix has a value of 255.

The pixel values at the positions b and d are generated by using a 6-tap FIR filter according to the following equation (5):

[Formula 2]

F=A₋₂−5*A₋₁+20*A₀+20*A₁−5*A₂+A₃b,d=Clip1((F+16)>>5) (5)

The pixel value at the position c is generated by applying a 6-tap FIR filter to the horizontal and perpendicular directions according to the following equation (6):

[Formula 3]

F=b₋₂−5*b₋₁+20*b₀+20*b₁−5*b₂+b₃

Or

F=d₋₂−5*d₋₁+20*d₀+20*d₁−5*d₂+d₃c=Clip1((F+512)>>10) (6)

The Clip processing is executed once at the last after the sum of products processing in both the horizontal and perpendicular directions.

The positions e1 to e3 are generated by linear interpolation according to the following equation (7):

[Formula 4]

e₁=(A+b+1)>>1

e₂=(b+d+1)>>1

e₃=(b+c+1)>>1 (7)

For example, according to MPEG-2 standard, motion prediction/compensation is performed in the unit of 16×16 pixels in the case of frame motion compensation modes, and in the unit of 16×8 pixels for a first field and a second field in the case of field motion compensation modes.

On the other hand, in the motion prediction/compensation according to H.264/AVC standard, while the macroblock size is 16×16 pixels, motion prediction/compensation is performed with variable block sizes.

FIG. 3 depicts exemplary block sizes for motion prediction/compensation according to H.264/AVC standard.

In the upper row of FIG. 3, macroblocks comprising 16×16 pixels are depicted in order from the left, each macroblock being divided into the partitions of 16×16 pixels, 16×8 pixels, 8×16 pixels, and 8×8 pixels. In the lower row of FIG. 3, blocks comprising 8×8 pixels are depicted in order from the left, each block being divided into the subpartitions of 8×8 pixels, 8×4 pixels, 4×8 pixels, and 4×4 pixels.

In other words, according to H.264/AVC standard, one macroblock may be divided into any of partitions of 16×16 pixels, 16×8 pixels, 8×16 pixels, or 8×8 pixels, so as to have pieces of motion vector information independent of one another. A partition of 8×8 pixels may be divided into any of subpartitions of 8×8 pixels, 8×4 pixels, 4×8 pixels, or 4×4 pixels, so as to have pieces of motion vector information independent of one another.

Further, according to H.264/AVC standard, prediction/compensation processing involving multi-reference frames is also performed.

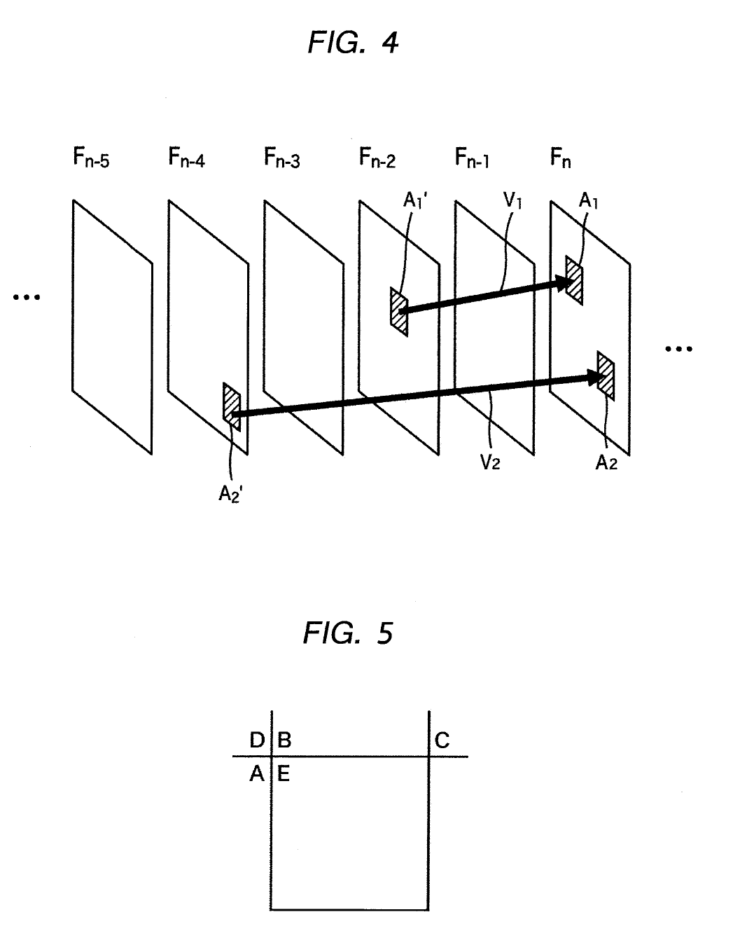

FIG. 4 is an explanatory diagram of prediction/compensation processing involving multi-reference frames according to H.264/AVC standard. According to H.264/AVC standard, a motion prediction/compensation standard is defined for multi-reference frames.

The example of FIG. 4 depicts a current frame Fn about to be encoded and encoded frames Fn−5, Fn−1. On the time axis, the frame Fn−1 is prior to the current frame Fn by one frame, the frame Fn−2 is prior to the current frame Fn by two frames, and the frame Fn−3 is prior to the current frame Fn by three frames. The frame Fn−4 is prior to the current frame Fn by four frames, and the frame Fn−5 is prior to the current frame Fn by five frames. Generally, a smaller reference picture number (ref_id) is added to a frame closer to the current frame Fn on the time axis. Specifically, the frame Fn−1 has the smallest reference picture number, and subsequently, the smaller reference picture numbers are assigned to the frames Fn−2, . . . , Fn−5 in this order.

The current frame Fn has blocks A1 and A2 depicted therein, and the block A1 is found to have relevancy to a block A1′ in the frame Fn−2 prior to the current frame by two frames, such that a vector V1 is found through search. The block A2 is found to have relevancy to a block A1′ in the frame Fn−4 prior to the current frame by four frames, such that a vector V2 is found through search.

As described above, according to H.264/AVC standard, a plurality of reference frames may be stored on a memory, such that different reference frames are referenceable in one frame (picture). More specifically, for example, the frame Fn−2 may be referenced with respect to the block A1, and the frame Fn−4 may be referenced with respect to the block A2; in this manner, one picture may have pieces of reference frame information (reference picture number (ref_id)) that are independent of one another on the block basis.

It is to be noted here that the blocks indicates any of the partitions described above with reference to FIG. 3, i.e., 16×16 pixels, 16×8 pixels, 8×16 pixels, or 8×8 pixels. Reference frames within 8×8 subblocks have to be the same.

As described above, according to H.264/AVC standard, motion prediction/compensation processing at ¼ pixel accuracy that is described with reference to FIG. 2 and motion prediction/compensation processing that is described with reference to FIGS. 3 and 4 are performed, such that a huge amount of pieces of motion vector information are generated. Encoding such a huge amount of pieces of motion vector information as they are may invite lowering of coding efficiency. On the other hand, according to H.264/AVC, reduction in information to be encoded for motion vectors are achieved by a method depicted in FIG. 5.

FIG. 5 is an explanatory diagram of a method of generating motion vector information according to H.264/AVC standard.

The example of FIG. 5 depicts a current block E about to be encoded (for example, 16×16 pixels) and blocks A to D that are adjacent the current block E and have already been encoded.

Specifically, the block D is adjacent the current block E on the upper left, the block B is adjacent the current block E on the upper side, the block C is adjacent the current block E on the upper right, and the block A is adjacent the current block E on the left. It is to be noted that the blocks A to D are not defined so as to signify that the blocks comprise any of the above-described 16×16 pixels to 4×4 pixels as described with reference to FIG. 3.

For example, motion vector information for X (=A, B, C, D, E) is represented by mv_{X}. First, prediction motion vector information pmv_{E} for the current block E is generated by means of median prediction according to the following equation (8) by using motion vector information for the blocks A, B, and C:

pmv_{E}=med(mv_{A},mv_{B},mv_{C}) (8)

The motion vector information for the block C may be unavailable in some cases for the reasons that, for example, the motion vector information is at an edge of the picture frame or has not been encoded yet. In this case, the motion vector information for the block D is used in place of the motion vector information for the block C.

Data mvd_{E} to be added to the header portion of a compressed image as motion vector information for the current block E is generated according to the following equation (9) by using pmv_{E}:

mvd_{E}=mv_{E}−pmv_{E} (9)

In actuality, processing is performed independently on the respective components of motion vector information in the horizontal and perpendicular directions.

In this manner, prediction motion vector information is generated, and difference between the prediction motion vector information and the motion vector information that have been generated based on the relevancy with an adjacent block is added to the header portion of a compressed image; thus, reduction in motion vector information is achieved.

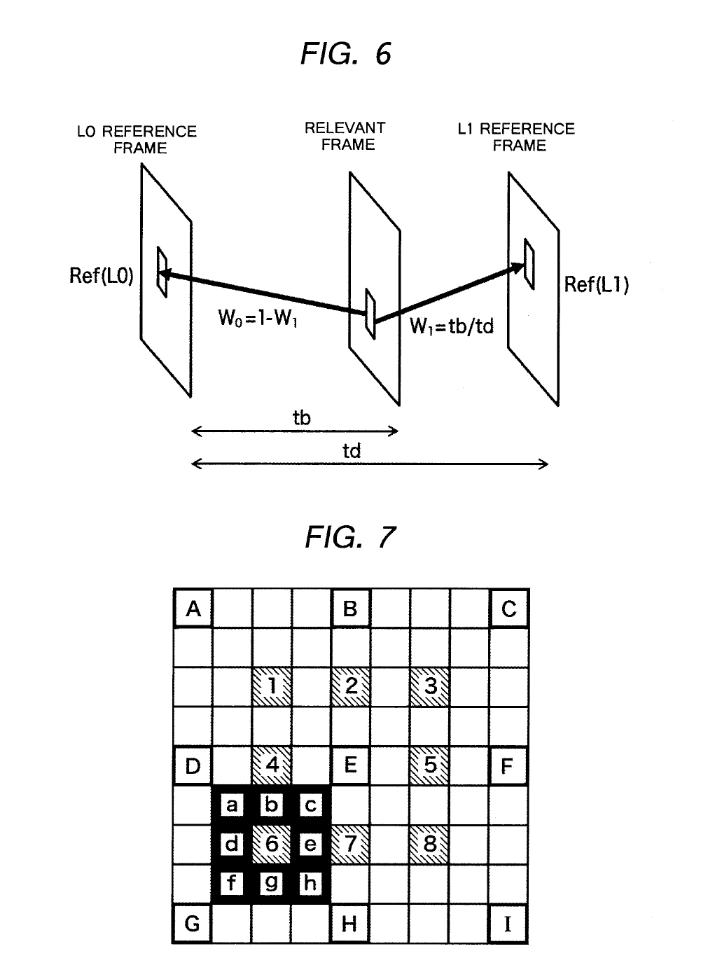

Description is given next with reference to FIG. 6 of a method of calculating the weight factor W and the offset value D in the case of Implicit Mode for B pictures according to H.264/AVC standard.

As described above, weighted prediction according to H.264/AVC standard is performed according to the equation (1) for P pictures and according to the equation (2) for B pictures.

Further, according to H.264/AVC standard, whether or not to use the weighted prediction may be specified in the unit of slices, and Explicit Mode and Implicit Mode are defined. Explicit Mode is a mode for transmission with W and D added to slice headers and may be used both for P pictures and B pictures. On the other hand, Implicit Mode is a mode wherein W is calculated based on the distance on the time axis between the relevant picture and a reference picture thereof and is used for B pictures.

The example of FIG. 6 depicts an L0 reference frame temporally before the relevant frame and an L1 reference frame temporally after the relevant frame. The temporal distance information between the L0 reference frame and the relevant frame is represented as tb, whereas the temporal distance information between the L0 reference frame and the L1 reference frame is represented as td. As corresponding information does not exist for the temporal distance information in H.264/AVC standard, POC (Picture Order Count) is used.

A reference block Ref (L0) corresponding to the block in the relevant frame and an L1 reference block Ref (L1) corresponding to the block are depicted on the L0 reference frame and the L1 reference frame, respectively.

Prediction images in such a case are calculated in Implicit Mode according to the following equation (10) where the weight factor for Ref (L0) is defined as W₀ and the weight factor for Ref (L1) is defined as W₁, and the offset value is defined as D:

Prediction image=w₀*Ref(L0)+W₁*Ref(L1)+D

W₀=1−W₁

W₁=tb/td

D=0 (10)

Incidentally, by what processing the motion vector to be found at ¼ pixel accuracy described with reference to FIG. 2 matters in obtaining compressed images providing for higher coding efficiency. According to H.264/AVC standard, used as an example of the processing is a published method that is implemented on reference software referred to as JM (Joint Model).

Description is given next of the method of motion search implemented on JM with reference to FIG. 7.

In the example of FIG. 7, the pixels A to I indicate pixels having pixel values at integer pixel accuracy (hereinafter referred to as integer pixel accuracy pixels). The pixels 1 to 8 indicate pixels having pixel values at ½ pixel accuracy in the vicinity of the pixel E (hereinafter referred to as ½ pixel accuracy pixels). The pixels a to h indicate pixels having pixel values at ¼ pixel accuracy in the vicinity of pixel 6 (hereinafter referred to as ¼ pixel accuracy pixels).

In JM, as a first step, a motion vector at integer pixel accuracy is found so as for the cost function value such as SAD (Sum of Absolute Difference) to have a minimum value within a predetermined search range. It is assumed here that the pixel indicated by the motion vector thus found is the pixel E.

Next, as a second step, the pixel having a pixel value that gives the minimum cost function value is found from the pixel E and the pixels 1 to 8 at ½ pixel accuracy in the vicinity of the pixel E, and the pixel (the pixel 6 in the example of FIG. 2) is defined as the pixel indicated by an optimum motion vector at ½ pixel accuracy.

As a third step, the pixel having a pixel value that gives the minimum cost function value is found from the pixel 6 and the pixels a to h at ¼ pixel accuracy in the vicinity of the pixel 6. Thus, the motion vector indicating the pixel found is an optimum motion vector at ¼ pixel accuracy.

Further, in order to attain higher coding efficiency, selection of an appropriate prediction mode matters. According to H.264/AVC standard, a method is employed in which selection is made, for example, from two kinds of mode determining methods, i.e., High Complexity Mode and Low Complexity Mode that are defined in JM. According to this method, the respective cost function values are calculated with respect to the prediction modes, and the prediction mode that gives the minimum cost function value is selected as an optimum mode for the block or macroblock.

The cost function value in High Complexity Mode is calculable according to the following equation (11).

Cost(ModeεΩ)=D+λ×R (11)

In the equation (11), Ω indicates the universal set of candidate modes for encoding the block or macroblock. Further, D indicates the energy difference between the decoded image and the input image in the case of performing encoding in the relevant prediction Mode. λ is the Lagrange undetermined multiplier given as a function of a quantization parameter. R is the total amount of encoding including orthogonal transform coefficients in the case of performing encoding in the relevant Mode.

Specifically, in order to perform encoding in High Complexity Mode, provisional encoding processing has to be performed once in all the candidate Modes so as to calculate the above parameters of D and R, which entails a larger amount of arithmetic operation.

On the other hand, the cost function value in Low Complexity Mode is calculable by the following equation (12):

Cost(Mode εΩ)=D+QP2Quant(QP)×HeaderBit (12)

In the equation (12), unlike High Complexity Mode, D indicates the energy difference between the prediction image and the input image. QP2Quant (QP) is given as a function of a quantization parameter QP. Further, HeaderBit indicates the amount of encoding relating to the information belonging to the Header, such as motion vectors and modes, that does not include orthogonal transform coefficients.

Specifically, in Low Complexity Mode, while prediction processing has to be performed per candidate Mode, decoded images are not used, and encoding processing thus does not have to be performed. As such, a smaller amount of arithmetic operation suffices as compared with High Complexity Mode.

H.264/AVC standard as described above is appropriately used in the image coding apparatus 51 of FIG. 1.

### Detailed Configuration Example

In this image coding apparatus 51, different weighted prediction methods are used according to the color formats of input signals. Specifically, weighted prediction similar to that of H.264/AVC standard is performed at the weighted predictor 76 in the case where the input signal is in RGB format. Meanwhile, in the case where the input signal is in YCbCr format, weighted prediction processing is performed differently on the luminance signal and the chrominance signal.

Specifically, in the case where the input signal is in YCbCr format, weighted prediction is performed at the weighted predictor 76 on the luminance signal according to the above-described equations (1) and (2). On the other hand, regarding the chrominance signal, it is assumed that the image signal to constitute the inputs is represented in n bit, and prediction signals are generated according to the following equation (13) instead of the equation (1) for P pictures:

Prediction signal=W₀*(Y₀−2ⁿ⁻¹)+D+2ⁿ⁻¹ (13)

where the value of 2ⁿ⁻¹ is 2⁷=128 in the case of an 8-bit video.

Regarding the chrominance signal, prediction signals are generated according to the following equation (14) instead of the equation (2) for B pictures:

Prediction signal=W₀*(Y₀−2ⁿ⁻¹)+W₁*(Y₁−2ⁿ⁻¹)+D+2ⁿ⁻¹ (14)

As described above, it is so configured that weighted prediction is performed differently on the luminance signal and the chrominance signal in the case where the input signal is in YCbCr format.

Specifically, while weighted prediction is performed in the same manner as according to H.264/AVC standard for the luminance signal, weighted prediction of the chrominance signal is performed such that, as shown in the equations (13) and (14), 2ⁿ⁻¹ is subtracted in multiplication, and 2ⁿ⁻¹ is added after that. Specifically, weighted prediction is performed on chrominance components according to the input bit accuracy and the picture type of the image. Thus, weighted prediction of the chrominance signal, of which prediction efficiency is used to be lower, is possible without entailing lowering of prediction efficiency.

### Configuration Example of Motion Predictor/Compensator and Weighted Predictor

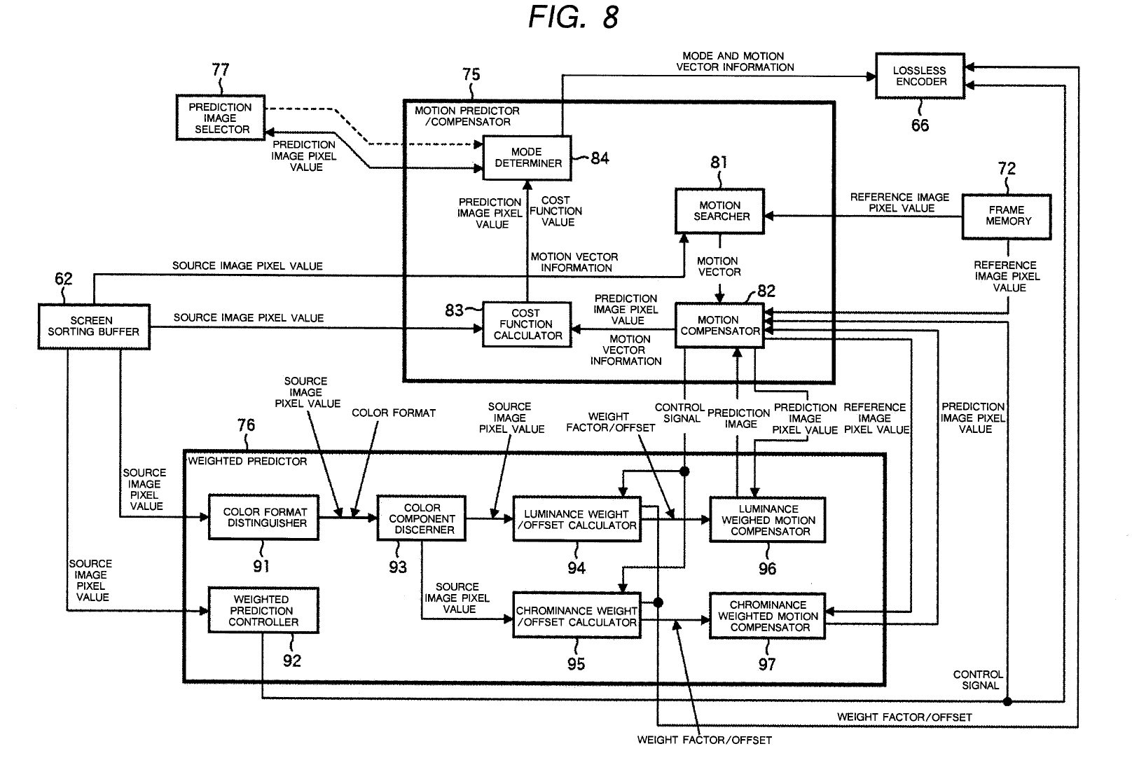

FIG. 8 is a block diagram depicting a detailed configuration example of the motion predictor/compensator 75 and the weighted predictor 76. The switch 73 in FIG. 1 is not shown in FIG. 8.

In the example of FIG. 8, the motion predictor/compensator 75 includes a motion searcher 81, a motion compensator 82, a cost function calculator 83, and a motor determiner 84.

The weighted predictor 76 includes a color format distinguisher 91, a weighted prediction controller 92, a color component discerner 93, a luminance weight/offset calculator 94, a chrominance weight/offset calculator 95, a luminance weighted motion compensator 96, and a chrominance weighted motion compensator 97.

The pixel values of source images to be subjected to inter processing from the image sorting buffer 62 are inputted to the motion searcher 81, the cost function calculator 83, the color format distinguisher 91, and the weighted prediction controller 92.

In addition to source image pixel values, reference image pixel values from the frame memory 72 are also inputted to the motion searcher 81. The motion searcher 81 performs motion search in all inter prediction modes and decides optimum pieces of motion vector information in the inter prediction modes, respectively, so as to supply the information to the motion compensator 82. These pieces of motion vector information may be generated finally (i.e., at the time of encoding) as described earlier with reference to FIG. 5.

The motion compensator 82 is supplied from the weighted prediction controller 92 with control signals indicating that weighted prediction be performed or not be performed. In the case where weighted prediction is not performed, the motion compensator 82 performs compensation processing on reference images from the frame memory 72 by using motion vector information from the motion searcher 81, so as to generate prediction images. At this time, the motion compensator 82 supplies the generated prediction image pixel values and the motion vector information corresponding thereto to the cost function calculator 83.

In the case where weighted prediction is performed, the motion compensator 82 supplies to the luminance weighted motion compensator 96 luminance signals and chrominance signals of the reference image pixel values referred to by the motion vector information when the color format of signals to be processed (reference image) is RGB format. The motion compensator 82 supplies, of the reference image pixel values referred to by the motion vector information, luminance signals to the luminance weighted motion compensator 96 and color signals to the chrominance weighted motion compensator 97 in the case of YCbCr format. Then, the motion compensator 82 receives from the luminance weighted motion compensator 96 and the chrominance weighted motion compensator 97 the prediction image pixel values generated correspondingly.

The motion compensator 82 supplies to the cost function calculator 83 motion vector information corresponding to the prediction image pixel values received. In the case where weighted prediction is performed, the motion compensator 82 outputs control signals that indicate to that effect to the luminance weight/offset calculator 94 and the chrominance weight/offset calculator 95.

The cost function calculator 83 uses source image pixel values from the screen sorting buffer 62 and prediction image from the motion compensator 82 to calculate the respective cost function values for the inter prediction modes according to the above-described equation (11) or (12), and outputs the prediction images and motion vector information that correspond to the calculated cost function values, for output to the mode determiner 84.

Inputted to the mode determiner 84 are the cost function values calculated by the cost function calculator 83 and the prediction images and motion vector information corresponding thereto. The mode determiner 84 decides, of the cost function values inputted, a minimum one as an optimum inter mode for the macroblock, and outputs prediction images that correspond to this prediction mode to the prediction image selector 77.

In the case where a prediction image in the optimum inter mode is selected by the prediction image selector 77, a signal indicative to that effect is supplied from the prediction image selector 77. Thus, the mode determiner 84 supplies the optimum inter mode information and motion vector information to the lossless encoder 66.

The color format distinguisher 91 uses source image pixel values from the screen sorting buffer 62 to distinguish which of RGB and YCbCr the format of the source image is, and outputs the color format distinguished and the source image pixel values to the color component discerner 93.

The weighted prediction controller 92 uses source image pixel values from the screen sorting buffer 62 to perform detection as to whether brightness of the screen changes between frames due to, for example, fading in the source image. The weighted prediction controller 92 decides according to the result of detection whether or not weighted prediction is used in the relevant slice and supplies to the motion compensator 82 control signals indicating whether or not weighted prediction be performed. The control signals indicating whether or not weighted prediction be performed are also supplied to the lossless encoder 66 as flag information.

In the case where the source image (input signals) is in RGB format, the color component discerner 93 outputs the source image pixel values fully to the luminance weight/offset calculator 94. In the case where the source image (input signals) is in YCbCr format, the color component discerner 93 outputs, of the source image pixel values, luminance components to the luminance weight/offset calculator 94 and chrominance components to the chrominance weight/offset calculator 95.

When receiving control signals from the motion compensator 82, the luminance weight/offset calculator 94 performs calculation of weight factors and offset values for weighted prediction based either on Explicit Mode or Implicit Mode. When receiving the control signals from the motion compensator 82, the chrominance weight/offset calculator 95 also performs calculation of weight factors and offset values for weighted prediction based either on Explicit Mode or Implicit Mode. In the case of Implicit Mode, weighted factors are calculated according to the above-described equation (10). With respect to B pictures, which of the Modes to be used is set by users in advance.

The luminance weight/offset calculator 94 outputs the calculated weight factors and offset values to the luminance weighted motion compensator 96. The chrominance weight/offset calculator 95 outputs the calculated weight factors and offset values to the chrominance weighted motion compensator 97.

In the case of Explicit Mode, the luminance weight/offset calculator 94 and the chrominance weight/offset calculator 95 also supply the calculated weight factors and offset values to the lossless encoder 66.

When receiving the reference image pixel values referred to by the motion vector information from the motion compensator 82, the luminance weighted motion compensator 96 uses weight factors and offset values from the luminance weight/offset calculator 94 to perform weighted prediction processing on luminance signals and chrominance signals (in the case of RGB), so as to generate prediction image pixel values. The generated prediction image pixel values are outputted to the motion compensator 82.

When receiving the reference image pixel values referred to by the motion vector information from the motion compensator 82, the chrominance weighted motion compensator 97 uses weight factors and offset values from the chrominance weight/offset calculator 95 to perform weighted prediction processing on chrominance signals (in the case of YCbCr), so as to generate prediction image pixel values. The generated prediction image pixel values are outputted to the motion compensator 82.

### Description of Encoding Processing at Image Coding Apparatus

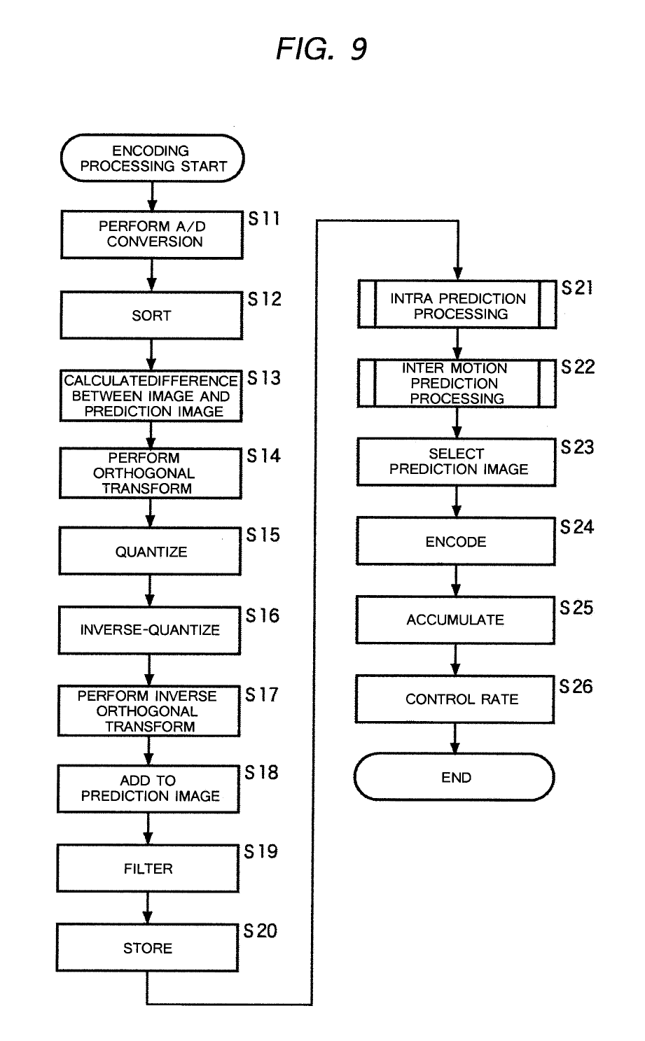

Description is given next of the encoding processing at the image coding apparatus 51 of FIG. 1 with reference to the flowchart of FIG. 9.

In step S11, the A/D converter 61 performs A/D conversion on input images. In step S12, the screen sorting buffer 62 retains the images supplied from the A/D converter 61 and sorts the pictures thereof from the display order into the encoding order.

In step S13, the arithmetic operator 63 calculates difference between the images sorted in step S12 and prediction images. The prediction images are supplied through the prediction image selector 77 from the motion predictor/compensator 75 in the case of inter prediction and from the intra predictor 74 in the case of intra prediction, to the arithmetic operator 63.

The difference data has a smaller data amount as compared with the original image data. Thus, the data amount is compressible in comparison with the case of encoding the image itself.

In step S14, the orthogonal transformer 64 performs orthogonal transform on the difference information supplied from the arithmetic operator 63. Specifically, orthogonal transform such as discrete cosine transform or Karhunen-Loeve transform is performed, such that transform coefficients are outputted. In step S15, the quantizer 65 quantizes the transform coefficients. In quantizing, the rate is controlled as described in the processing in step S26 to be described later.

The difference information thus quantized is decoded locally as described hereinafter. Specifically, in step S16, the inverse quantizer 68 performs inverse quantization on the transform coefficients quantized by the quantizer 65 with the characteristics corresponding to the characteristics of the quantizer 65. In step S17, the inverse orthogonal transformer 69 performs inverse orthogonal transform on the transform coefficients inverse-quantized by the inverse quantizer 68 with the characteristics corresponding to the characteristics of the orthogonal transformer 64.

In step S18, the arithmetic operator 70 adds prediction images to be inputted through the prediction image selector 77 to the locally decoded difference information and generates locally decoded images (images corresponding to the inputs to the arithmetic operator 63). In step S19, the deblocking filter 71 filters the images outputted from the arithmetic operator 70, so as to remove block distortion. In step S20, the frame memory 72 stores the images filtered. The frame memory 72 is supplied with images that have not been filtered by the deblocking filter 71 also from the arithmetic operator 70 for storage.

In the case where the images to be processed that are supplied from the image sorting buffer 62 are of blocks to be subjected to intra processing, decoded images to be referenced are read from the frame memory 72, so as to be supplied to the intra predictor 74 through the switch 73.

Based on these images, in step S21, the intra predictor 74 performs intra prediction on the pixels of the blocks to be processed in all candidate intra prediction modes. Pixels yet to be subject to deblocking filtering with the deblocking filter 71 are used as the decoded pixels to be referenced.

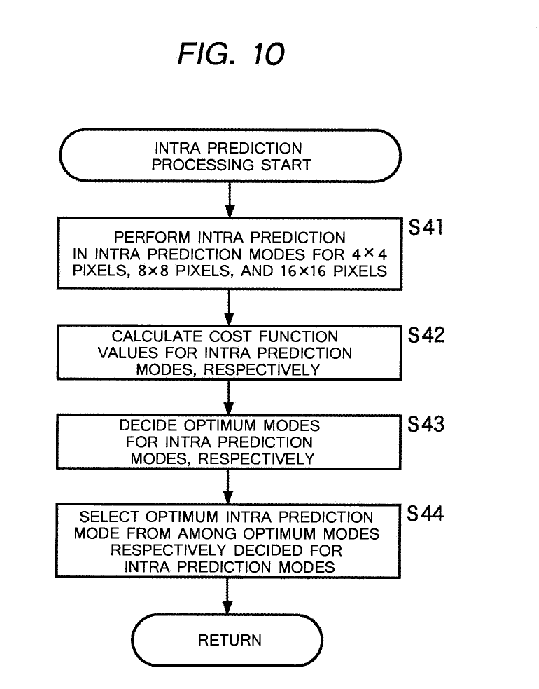

While the details of the intra prediction processing in step S21 are described later with reference to FIG. 10, intra prediction is performed in all the candidate intra prediction modes by this processing, and cost function values for all the candidate intra prediction modes are calculated. Based on the calculated cost function values, an optimum intra prediction mode is selected, and the prediction images generated by intra prediction in the optimum intra prediction mode and the cost function values thereof are supplied to the prediction image selector 77.

In the case where the processing target images to be supplied from the screen sorting buffer 62 are images to be subjected to inter processing, images to be referenced are read from the frame memory 72 and are supplied to the motion predictor/compensator 75 through the switch 73. Based on these images, in step S22, the motion predictor/compensator 75 perform inter motion prediction processing.

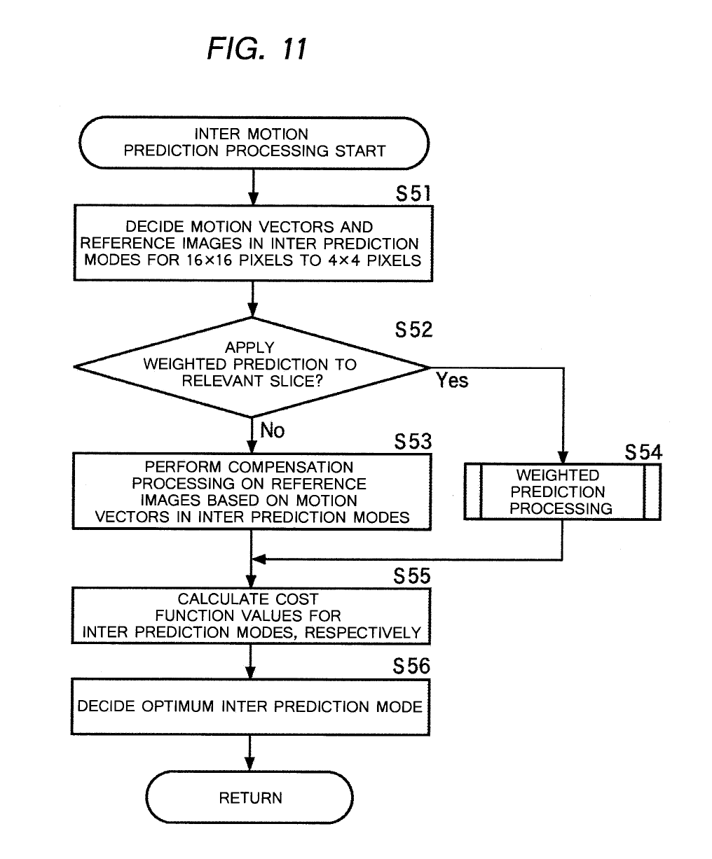

The details of the inter motion prediction processing in step S22 are described later with reference to FIG. 11. Whether to perform weighted prediction is determined through this processing. Motion search processing is performed in all the candidate inter prediction modes for the case where weighted prediction be performed or weighted prediction not be performed, cost function values are calculated for all the candidate inter prediction modes, and an optimum inter prediction mode is decided based on the cost function values calculated. The prediction images generated in the optimum inter prediction mode and the cost function values thereof are supplied to supplies to the prediction image selector 77.

In step S23, the prediction image selector 77 decides, based on the cost function values that have been outputted from the intra predictor 74 and the motion predictor/compensator 75, either the optimum intra prediction mode or the optimum inter prediction mode as an optimum prediction mode. Then, the prediction image selector 77 selects prediction images in the decided optimum prediction mode and supplies the images to the arithmetic operators 63 and 70. As described earlier, these prediction images are used for the arithmetic operations in steps S13 and S18.

The selection information on the prediction images is supplied to the intra predictor 74 or to the motion predictor/compensator 75. In the case where a prediction image in the optimum intra prediction mode is selected, the intra predictor 74 supplies the information indicating the optimum intra prediction mode (i.e., the intra prediction mode information) to the lossless encoder 66.

In the case where a prediction image in the optimum inter prediction mode is selected, the motion predictor/compensator 75 outputs the information indicating the optimum inter prediction mode, and in addition, information corresponding to the optimum inter prediction mode as needed, to the lossless encoder 66. The information corresponding to the optimum inter prediction mode includes motion vector information and reference frame information. Also outputted to the lossless encoder 66 are flag information indicating that weighted prediction be performed or not be performed and, in the case where the weighted prediction is in Explicit Mode, information of weight factors and offset values from the weighted predictor 76.

In step S24, the lossless encoder 66 encodes the quantized transform coefficients that have been outputted from the quantizer 65. In other words, the difference images are subjected to lossless coding such as variable length coding or binary arithmetic coding for compression. At this time, the intra prediction mode information from the intra predictor 74 that has been inputted to the lossless encoder 66 in the above-described step S21, or the optimum inter prediction mode-related information from the motion predictor/compensator 75 as well as the information from the weighted predictor 76 in step S22, is encoded to be included into header information.

For example, the information indicating the inter prediction mode is encoded per macroblock. The motion vector information and the reference frame information are encoded per current block. The information on the weighted prediction from the weighted predictor 76 is encoded per slice.

In step S25, the accumulation buffer 67 accumulates difference images as compressed images. The compressed images thus accumulated in the accumulation buffer 67 are appropriately read therefrom to be transmitted to the decoding side through a channel.

In step S26, the rate controller 78 controls the rate of quantizing operation of the quantizer 65 based on the compressed images accumulated in the accumulation buffer 67 so as to protect from overflow or underflow.

### Description of Intra Prediction Processing

Description is given next of the intra prediction processing in step S21 of FIG. 9 with reference to the flowchart of FIG. 10. In the example of FIG. 10, the case of luminance signals is exemplarily described.

In step S41, the intra predictor 74 performs intra prediction in intra prediction modes for 4×4 pixels, 8×8 pixels, and 16×16 pixels, respectively.

The intra prediction modes for the luminance signal include prediction modes based on nine kinds of block units in 4×4 pixels and 8×8 pixels, as well as prediction modes based on four kinds of macroblock units in 16×16 pixels, whereas the intra prediction modes for the chrominance signal include prediction modes based on four kinds of block units in 8×8 pixels. The intra prediction modes for the chrominance signal are settable independently of the intra prediction modes for the luminance signal. With respect to the intra prediction modes for the luminance signal on the basis of 4×4 pixels and 8×8 pixels, one intra prediction mode is defined per block for luminance signals of 4×4 pixels and 8×8 pixels. With respect to the intra prediction modes for the luminance signal on the basis of 16×16 pixels and the intra prediction modes for the chrominance signal, one prediction mode is defined for one macroblock.

Specifically, the intra predictor 74 performs intra prediction on the pixels of processing current blocks with reference to decoded images to be read from the frame memory 72 and supplied through the switch 73. The intra prediction processing is each performed in intra prediction modes, such that prediction images are each generated in the intra prediction modes. Pixels that have not undergone deblocking filtering by the deblocking filter 71 are used as the decoded pixels to be referenced.

In step S42, the intra predictor 74 calculates cost function values with respect to the intra prediction modes for 4×4 pixels, 8×8 pixels, and 16×16 pixels. Herein, the cost functions of the above-described equation (11) or (12) are used to find the cost function values.

In step S43, the intra predictor 74 decides optimum modes in the intra prediction modes for 4×4 pixels, 8×8 pixels, and 16×16 pixels, respectively. Specifically, as described above, the intra 4×4 prediction mode and intra 8×8 prediction mode have nine kinds of prediction modes, and the intra 16×16 prediction mode has four kinds of prediction modes. Hence, the intra predictor 74 decides an optimum intra 4×4 prediction mode, an optimum intra 8×8 prediction mode, and an optimum intra 16×16 prediction mode from the above based on the cost function values calculated in step S42.

In step S44, the intra predictor 74 selects an optimum intra prediction mode based on the cost function values calculated in step S42 from among the optimum modes that have been decided on the intra prediction modes for 4×4 pixels, 8×8 pixels, and 16×16 pixels, respectively, in step S44. More specifically, of the optimum modes decided for 4×4 pixels, 8×8 pixels, and 16×16 pixels, a mode that has a minimum cost function value is selected as an optimum intra prediction mode. The intra predictor 74 supplies the prediction images generated in the optimum intra prediction mode and the cost function values thereof to the prediction image selector 77.

### Description of Inter Motion Prediction Processing

Description is given next of the inter motion prediction processing in S22 of FIG. 9 with reference to the flowchart of FIG. 11.

In step S51, the motion searcher 81 decides motion vectors and reference images for eight kinds of inter prediction modes comprising 16×16 pixels to 4×4 pixels, respectively. More specifically, motion vectors and reference images are decided for processing current blocks in the inter prediction modes, respectively, and the motion vector information is supplied to the motion compensator 82.

The weighted prediction controller 92 uses source image pixel values from the screen sorting buffer 62 to detect whether brightness of the screen changes between frames of the source image, so as to determine whether or not weighted prediction is applied to the relevant slice. In step S52, in the case where determination is made that weighted prediction is not applied to the relevant slice, control signals indicating to that effect are supplied to the motion compensator 82.

In step S53, the motion compensator 82 performs compensation processing on the reference images based on the motion vector information decided in step S63 for the eight kinds of inter prediction modes comprising 16×16 pixels to 4×4 pixels. Prediction images are generated in the inter prediction modes through this compensation processing, and the generated prediction images are outputted to the cost function calculator 83 together with the motion vector information corresponding thereto.

Meanwhile, in step S52, in the case where determination is made that weighted prediction is applied to the relevant slice, control signals indicating to that effect are supplied to the motion compensator 82.

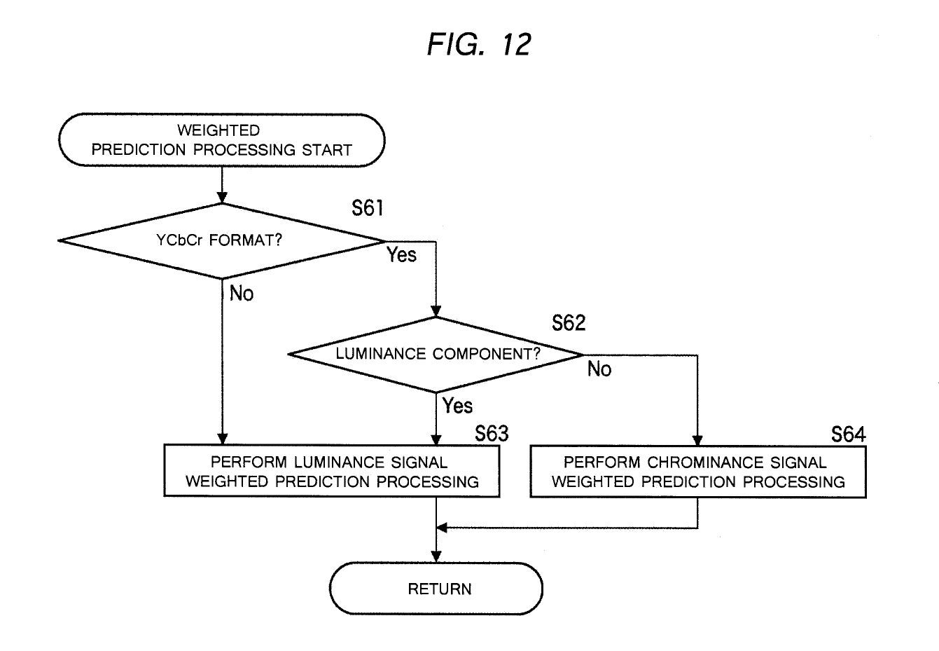

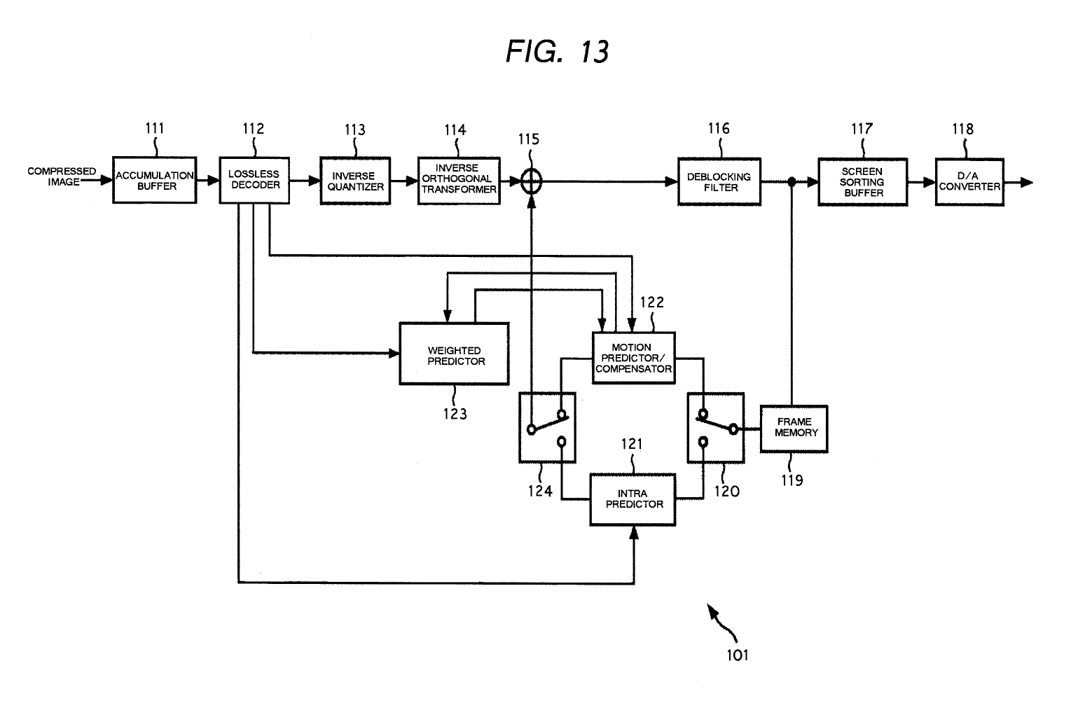

In step S54, the motion compensator 82 and the weighted predictor 76 execute weighted prediction processing. The details of this weighted prediction processing are described later with reference to FIG. 12.

Prediction images that resulted from the weighted prediction processing at the weighted predictor 76 by the process of step S54 are supplied to the motion compensator 82. The motion compensator 82 supplies the motion vector information corresponding to the prediction image pixel values to the cost function calculator 83.

In step S55, the cost function calculator 83 calculates cost function values represented by the above-described equation (11) or (12) for the eight kinds of inter prediction modes comprising 16×16 pixels to 4×4 pixels. The calculated cost function values and the corresponding prediction images as well as motion vector information are outputted to the mode determiner 84.

In step S56, the mode determiner 84 compares the cost function values calculated with respect to the inter prediction modes in step S53 and decides the prediction mode that gives a minimum value as an optimum inter prediction mode. Then, the mode determiner 84 supplies prediction images generated in the optimum inter prediction mode and the cost function values thereof to the prediction image selector 77.

In the case where a prediction image generated in the optimum inter prediction mode generated in the above step S23 of FIG. 9, information including the optimum inter prediction mode information and motion vector information is supplied to the lossless encoder 66 and is encoded in step S24.

Description is given next of the weighted prediction processing in step S54 of FIG. 11 with reference to the flowchart of FIG. 12.

The color format distinguisher 91 uses source image pixel values from the screen sorting buffer 62 to distinguish which of RGB and YCbCr the format of the source image is and outputs the identified color format and the source image pixel values to the color component discerner 93.

In step S61, the color component discerner 93 determines whether or not the format of the input signals (source image) is YCbCr format. In the case where determination is made that the format of the input signals is YCbCr format in step S61, the processing proceeds to step S62.

In step S62, the color component discerner 93 determines whether or not the input signals are luminance components. In the case where luminance components are determined in step S62, the color component discerner 93 outputs the input signals (luminance components) to the luminance weight/offset calculator 94, and the processing proceeds to step S63.

In the case where not YCbCr format but RGB format is determined in step S61 also, the processing proceeds to step S63. In other words, in this case, regardless of whether the input signals are luminance components or chrominance components, the input signals are outputted to the luminance weight/offset calculator 94 and the process of step S63 is performed thereat.

In step S63, the luminance weight/offset calculator 94 and the luminance weighted motion compensator 96 perform luminance signal weighted prediction.

More specifically, in the case where weighted prediction is performed, as the control signals from the motion compensator 82 are inputted, the luminance weight/offset calculator 94 performs calculation of weight factors and offset values for the weighted prediction of the equation (1) or (2) either based on Explicit Mode or Implicit Mode.

The luminance weight/offset calculator 94 outputs the calculated weight factors and offset values to the luminance weighted motion compensator 96. In the case of Explicit Mode, the luminance weight/offset calculator 94 supplies the calculated weight factors and offset values to the lossless encoder 66 also, and the lossless encoder 66 encodes them in the above-described step S24 of FIG. 9, so as to add the encoded result to the headers of compressed images.

Of the reference image pixel values referred to by the motion vector information, luminance signals and chrominance signals (in the case of RGB) are inputted from the motion compensator 82 to the luminance weighted motion compensator 96. In response thereto, the luminance weighted motion compensator 96 uses the weight factors and offset values (i.e., the equation (1) or (2)) from the luminance weight/offset calculator 94 to perform weighted prediction processing on the luminance signals or the chrominance signals (in the case of RGB), so as to generate prediction image pixel values. That is, in this case, weighted prediction based on H.264/AVC standard is performed. The generated prediction image pixel values are outputted to the motion compensator 82.

Meanwhile, in the case where not luminance components but chrominance components are determined in step S62, the color component discerner 93 outputs input signals (chrominance components) to the chrominance weight/offset calculator 95, and the processing proceeds to step S64.

In step S64, the chrominance weight/offset calculator 95 and the chrominance weighted motion compensator 97 perform weighted prediction for the luminance signal.

In the case where weighted prediction is performed, as the control signals from the motion compensator 82 are inputted, the chrominance weight/offset calculator 95 performs calculation of weight factors and offset values for the weighted prediction of equation (13) or (14) based either on Explicit Mode or Implicit Mode.

The chrominance weight/offset calculator 95 outputs the calculated weight factors and offset values to the chrominance weighted motion compensator 97. In the case of Explicit Mode, as the chrominance weight/offset calculator 95 supplies the calculated weight factors and offset values to the lossless encoder 66 also, the lossless encoder 66 encodes them in the above-described process of step S24 of FIG. 9, so as to add the encoded result to the headers of compressed images.

Of the reference image pixel values referred to by the motion vector information, chrominance signals (in the case of YCbCr) are inputted from the motion compensator 82 to the chrominance weighted motion compensator 97. In response thereto, the chrominance weighted motion compensator 97 uses weight factors and offset values (i.e., the equation (13) or (14)) from the chrominance weight/offset calculator 95 to perform weighted prediction processing on the chrominance signals (in the case of YCbCr), so as to generate prediction image pixel values. The generated prediction image pixel values are outputted to the motion compensator 82.

As described above, since different weight predictions are performed on luminance signals and chrominance signals in the case where input signals are in YCbCr format, weighted prediction on chrominance signals is implemented while obviating lowering of prediction efficiency.

In the foregoing, description is exemplarily given of motion search processing wherein weighted prediction is not performed and weighted prediction processing is performed on the motion vector information found through the search; however, the applicable scope of the present invention is not limited thereto. For example, motion search may be performed such that weighted prediction is taken into consideration. It may also be so configured that encoding processing is performed accordingly in the case of performing weighted prediction and in the case of not performing weighted prediction and calculation of cost function values is performed, such that the result of encoding involving the smaller cost function value is sent to the decoding side.

The encoded compressed images are transmitted through a specific channel, so as to be decoded by an image decoding apparatus.

### Configuration Example of Image Decoding Apparatus

FIG. 13 depicts the configuration of one embodiment of an image decoding apparatus serving as an image processing apparatus to which the present invention is applied.

An image decoding apparatus 101 includes an accumulation buffer 111, a lossless decoder 112, an inverse quantizer 113, an inverse orthogonal transformer 114, an arithmetic operator 115, a deblocking filter 116, a screen sorting buffer 117, a D/A converter 118, a frame memory 119, a switch 120, an intra predictor 121, a motion predictor/compensator 122, a weighted predictor 123, and a switch 124.

The accumulation buffer 111 accumulates compressed images that have been transmitted thereto. The lossless decoder 112 decodes the information that has been supplied from the accumulation buffer 111 and encoded by the lossless encoder 66 of FIG. 1 according to a system corresponding to the coding system adopted by the lossless encoder 66. The inverse quantizer 113 performs inverse quantization on the images decoded by the lossless decoder 112 according to a method corresponding to the quantization method adopted by the quantizer 65 of FIG. 1. The inverse orthogonal transformer 114 performs inverse orthogonal transform on the outputs from the inverse quantizer 113 according to a method corresponding to the orthogonal transform method adopted by the orthogonal transformer 64 of FIG. 1.

The inverse orthogonal transformed outputs are added by the arithmetic operator 115 to prediction images to be supplied from the switch 124 and are decoded. The deblocking filter 116 removes block distortion in the decoded images and then supplies the images to the frame memory 119 for accumulation, while outputting the images to the screen sorting buffer 117.

The screen sorting buffer 117 sorts images. More specifically, the order of the frames that has been sorted by the screen sorting buffer 62 of FIG. 3 into the encoding order is sorted into the original display order. The D/A converter 118 performs D/A conversion on the images supplied from the screen sorting buffer 117 and outputs the images to a display (not shown), so as for the images to be displayed thereon.

The switch 120 reads images to be subjected to inter processing and images to be referenced from the frame memory 119 and outputs the images to the motion predictor/compensator 122, while reading the images to be used in intra prediction from the frame memory 119 to supply the images to the intra predictor 121.

The intra predictor 121 is supplied from the lossless decoder 112 with the information indicating an intra prediction mode that has been obtained by decoding header information. The intra predictor 121 generates prediction images based on this information and outputs the generated prediction images to the switch 124.

Of the pieces of information obtained by decoding header information, the motion predictor/compensator 122 is supplied from the lossless decoder 112 with information including inter prediction mode information, motion vector information, reference frame information, and weighted prediction flag information. The inter prediction mode information is received per macroblock. The motion vector information and the reference frame information are received per current block. The weighted prediction flag information is received per slice.

According to the weighted prediction flag from the lossless decoder 112, the motion predictor/compensator 122 uses, in the case where weighted prediction is not performed, inter prediction mode information and motion vector information to be supplied from the lossless decoder 112, so as to generate the pixel values of prediction images for current blocks. More specifically, the motion predictor/compensator 122 uses motion vectors to perform, in the inter prediction mode from the lossless decoder 112, compensation processing on reference images from the frame memory 119, so as to generate prediction images. The generated prediction images are outputted to the switch 124.

The motion predictor/compensator 122 supplies to the weighted predictor 123, in the case where weighted prediction is performed, the reference images from the frame memory 119 that are referred to by the motion vector information from the lossless decoder 112. Being supplied with prediction images from the weighted predictor 123 in response thereto, the motion predictor/compensator 122 outputs the prediction images to the switch 124.

The weighted prediction flag information also contains mode information indicative of Explicit Mode or Implicit Mode. The motion predictor/compensator 122 supplies to the weighted predictor 123, in the case where weighted prediction is performed, control signals indicating that the weighted prediction be in Explicit Mode or in Implicit Mode.

Upon receiving the control signals indicating that the weighted prediction be in Explicit Mode from the motion predictor/compensator 122, the weighted predictor 123 uses weight factors and offset values from the lossless decoder 112 to perform weighted prediction on reference images from the motion predictor/compensator 122, so as to generate prediction images. Upon receiving the control signals indicating that the weighted prediction be in Implicit Mode from the motion predictor/compensator 122, the weighted predictor 123 uses the above-described equation (10) to calculate weight factors, and uses the calculated weight factors to perform weighted prediction on reference images from the motion predictor/compensator 122, so as to generate prediction images.

The generated prediction images are outputted through the motion predictor/compensator 122 to the switch 124.

The switch 124 selects prediction images that have been generated by the motion predictor/compensator 122 or the intra predictor 121 and supplies the images to the arithmetic operator 115.

It is to be noted here that, at the motion predictor/compensator 75 and the weighed predictor 76 of FIG. 1, prediction images have to be generated and cost function values have to be calculated for all candidate modes for mode determination. On the other hand, at the motion predictor/compensator 122 and the weighted predictor 123 of FIG. 13, mode information and motion vector information for blocks are received based on the headers of compressed images, and motion compensation processing using the pieces of information is performed.

### Configuration Examples of Motion Predictor/Compensator and Weighted Predictor

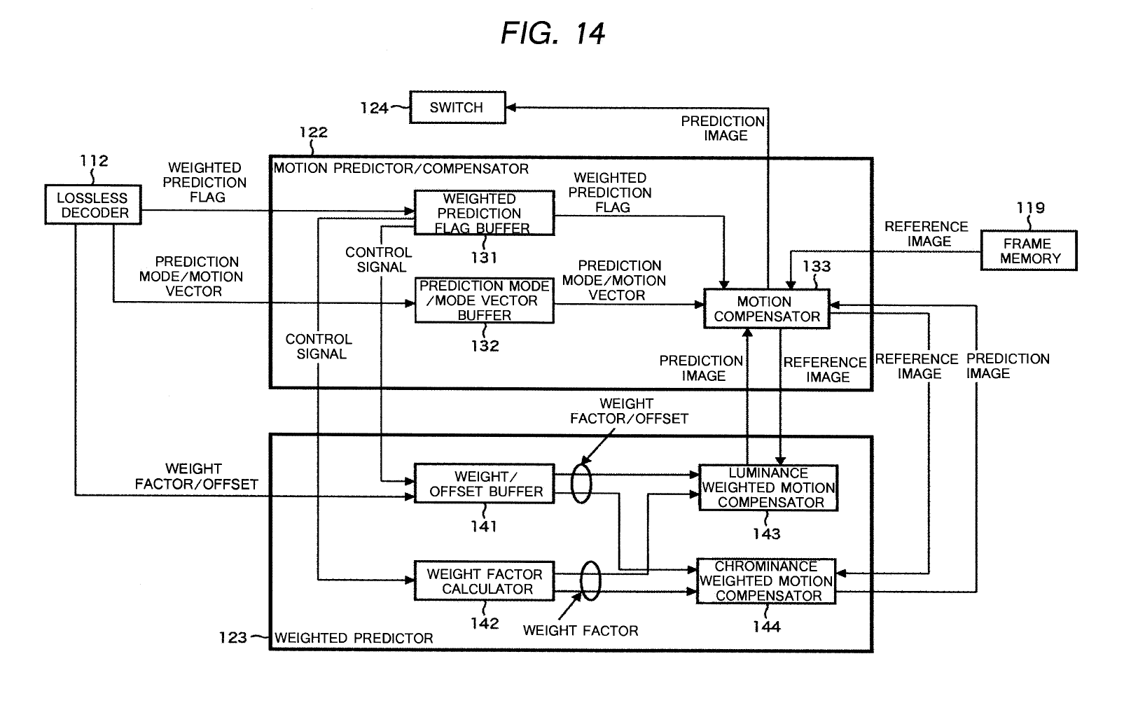

FIG. 14 is a block diagram depicting detailed configuration examples of the motion predictor/compensator 122 and the weighted predictor 123. In FIG. 14, the switch 120 of FIG. 13 is not depicted.

In the example of FIG. 14, the motion predictor/compensator 122 includes a weighted prediction flag buffer 131, a prediction mode/motion vector buffer 132, and a motion compensator 133.

The weighted predictor 123 includes a weight/offset buffer 141, a weight factor calculator 142, a luminance weighted motion compensator 143, and a chrominance weighted motion compensator 144.

The weighted prediction flag buffer 131 accumulates weighted prediction flag information contained in slice headers from the lossless decoder 112 for supply to the motion compensator 133. The weighted prediction flag information relates to whether prediction that does not involve weighted prediction be performed on the relevant slice, whether weighted prediction in Explicit Mode be performed, whether weighted prediction in Implicit Mode is performed.

In the case where weighted prediction in Explicit Mode is performed, the weighted prediction flag buffer 131 supplies the control signals therefor to the weight/offset buffer 141, whereas in the case where weighted prediction in Implicit Mode is performed, the control signals therefor are supplied to the weight factor calculator 142.

The prediction mode/motion vector buffer 132 accumulates motion vector information per block from the lossless decoder 112 and inter prediction mode information per macroblock, for supply to the motion compensator 133.

The motion compensator 133 uses, in the case where weighted prediction is not performed based on the weighted prediction flag information, the prediction mode and motion vector information from the prediction mode/motion vector buffer 132 to perform compensation processing on reference images from the frame memory 119, so as to generate prediction images. The generated prediction images are outputted to the switch 124.

In the case where weighted prediction is performed and the color format of the signals to be processed (reference images) is RGB format, the motion compensator 133 references the prediction mode from the prediction mode/motion vector buffer 132, and outputs to the luminance weighted motion compensator 143 luminance signals and chrominance signals of the reference images referred to by the motion vector information.

In the case where weighted prediction is performed and the color format is YCbCr format, the motion compensator 133 references the prediction mode from the prediction mode/motion vector buffer 132, and outputs to the luminance weighted motion compensator 143 luminance signals of the reference images referred to by the motion vector information. At this time, the motion compensator 133 outputs chrominance signals to the chrominance weighted motion compensator 144.

The weight/offset buffer 141 accumulates weight factors and offset values from the lossless decoder 112. In the case where weighted prediction in Explicit Mode is performed, control signals are incoming from the weighted prediction flag buffer 131. In response to the control signals, the weight/offset buffer 141 supplies the accumulated weight factors and offset values for luminance and chrominance to the luminance weighted motion compensator 143 and the chrominance weighted motion compensator 144, respectively.

In the case where weighted prediction in Implicit Mode is performed, control signals are incoming from the weighted prediction flag buffer 131. In response to the control signals, the weight factor calculator 142 calculates and accumulates weight factors for luminance and chrominance that are accumulated according to the above equation (10), for supply to the luminance weighted motion compensator 143 and the chrominance weighted motion compensator 144, respectively.

Upon receiving from the motion compensator 133 reference image pixel values referred to by the motion vector information, the luminance weighted motion compensator 143 uses the supplied weight factors (and offset values) to perform weighted prediction processing on luminance signals and chrominance signals (in the case of RGB), so as to generate prediction image pixel values. The generated prediction image pixel values are outputted to the motion compensator 133.

Upon receiving from the motion compensator 133 reference image pixel values referred to by the motion vector information, the chrominance weighted motion compensator 144 uses the supplied weight factors (and offset values) to perform weighted prediction processing on chrominance signals (in the case of YCbCr), so as to generate prediction image pixel values. The generated prediction image pixel values are outputted to the motion compensator 133.

### Description of Decoding Processing at Image Decoding Apparatus

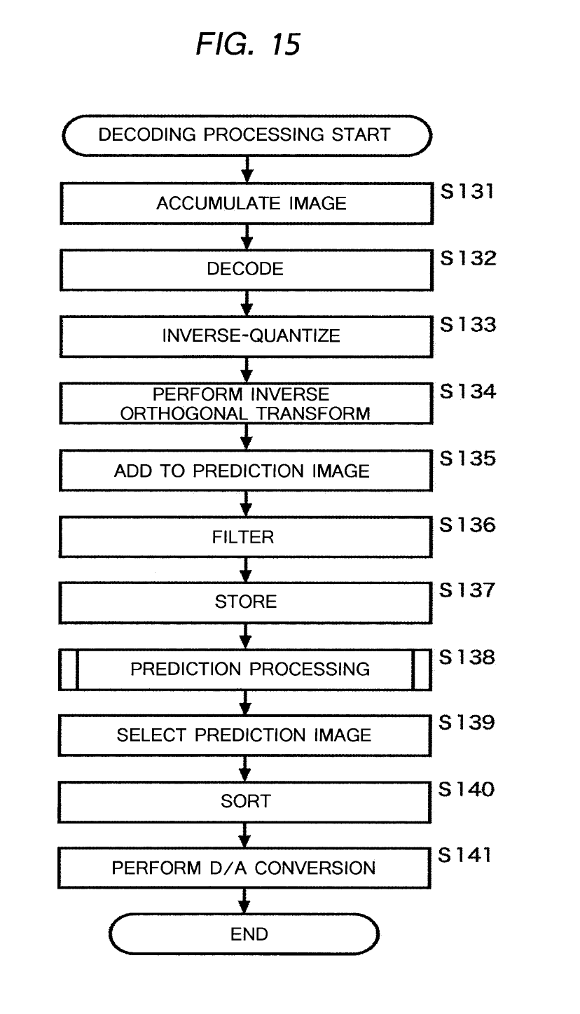

Description is given next of the decoding processing to be executed by the image decoding apparatus 101 with reference to the flowchart of FIG. 15.

In step S131, the accumulation buffer 111 accumulates images transmitted thereto. In step S132, the lossless decoder 112 decodes compressed images to be supplied from the accumulation buffer 111. Specifically, I pictures, P picture, and B pictures that have been encoded by the lossless encoder 66 of FIG. 1 are decoded.

At this time, information including motion vector information, reference frame information, prediction mode information (information indicating intra prediction mode or inter prediction mode), and weighted prediction flag information is also decoded. Moreover, in the case of Explicit Mode, weight factors and offset values are also decoded.

Specifically, in the case where the prediction mode information is intra prediction mode information, the prediction mode information is supplied to the intra predictor 121. In the case where the prediction mode information is inter prediction mode information, the prediction mode information and the corresponding motion vector information and reference frame information, in addition to the weighted prediction flag information, are supplied to the motion predictor/compensator 122. In the case of Explicit Mode, weight factors and offset values are supplied to the weighted predictor 123.

In step S133, the inverse quantizer 113 performs inverse quantization on the transform coefficients decoded by the lossless decoder 112 with the characteristics corresponding to the characteristics of the quantizer 65 of FIG. 1. In step S134, the inverse orthogonal transformer 114 performs inverse orthogonal transform on the transform coefficients inverse-quantized by the inverse quantizer 113 with characteristics corresponding to the characteristics of the orthogonal transformer 64 of FIG. 1. This completes decoding of difference information corresponding to the inputs to the orthogonal transformer 64 of FIG. 1 (the outputs from the arithmetic operator 63).

In step S135, the arithmetic operator 115 adds to the difference information prediction images that are to be selected and inputted through the switch 124 in the process of step S139 to be described later. Original images are decoded by this processing. In step S136, the deblocking filter 116 filters the images outputted from the arithmetic operator 115. Block distortion is thus removed. In step S137, the frame memory 119 stores the filtered images.

In step S138, the intra predictor 121 or the motion predictor/compensator 122 performs prediction processing on images according to prediction mode information to be supplied from the lossless decoder 112.

In the case where intra prediction mode information is supplied from the lossless decoder 112, the intra predictor 121 performs intra prediction processing in the intra prediction mode. In the case where inter prediction mode information is supplied from the lossless decoder 112, the motion predictor/compensator 122 performs weighted prediction according to the weighted prediction flag or motion prediction/compensation processing in an inter prediction mode that does not involve weighted prediction.

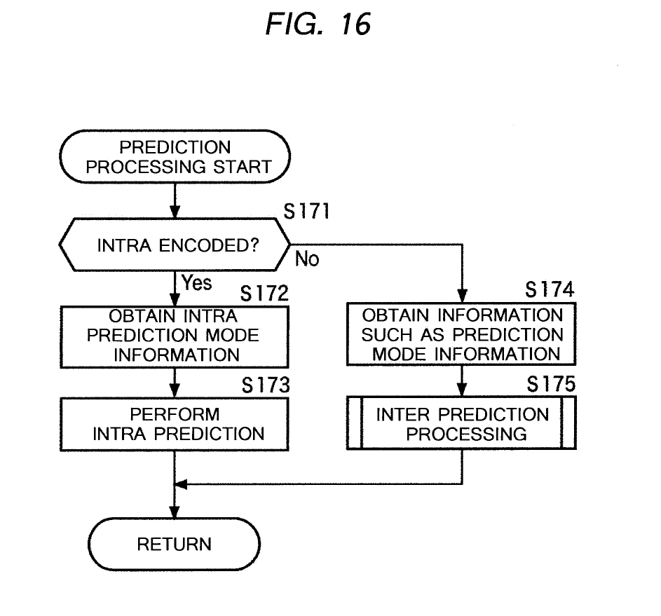

The details of the prediction processing in step S138 are described later with reference to FIG. 16. Through this processing, prediction images generated by the intra predictor 121 or prediction images generated by the motion predictor/compensator 122 are supplied to the switch 124.

In step S139, the switch 124 selects prediction images. More specifically, the prediction images generated by the intra predictor 121 or the prediction images generated by the motion predictor/compensator 122 are supplied. Hence, selection is made from among the supplied prediction images so as to be outputted to the arithmetic operator 115, and, as described above, the selected images are added to the outputs from the inverse orthogonal transformer 114 in step S135.

In step S140, the image sorting buffer 117 performs sorting. Specifically, the frame order that has been sorted by the screen sorting buffer 62 of the image coding apparatus 51 for encoding is sorted into the original display order.

In step S141, the D/A converter 118 performs D/A conversion on the images from the screen sorting buffer 117. These images are outputted to a display (not shown), and the images are displayed thereon.

### Description of Prediction Processing of Image Decoding Apparatus

Description is given of the prediction processing in step S138 of FIG. 15 with reference to the flowchart of FIG. 16.

In step S171, the intra predictor 121 determines whether or not the current block is intra-encoded. When intra prediction mode information is supplied to the intra predictor 121 from the lossless decoder 112, the intra predictor 121 determines in step S171 that the current block is intra-encoded, and the processing proceeds to step S172.

The intra predictor 121 obtains the intra prediction mode information in step S172 and performs intra prediction in step S173.

More specifically, in the case where the image to be processed is an image to be subjected to intra processing, images for use are read from the frame memory 119 and supplied through the switch 120 to the intra predictor 121. In step S173, the intra predictor 121 performs intra prediction according to the intra prediction mode information obtained in step S172, so as to generate prediction images. The generated prediction images are outputted to the switch 124.

Meanwhile, in the case where intra encoding is not determined in step S171, the processing proceeds to step S174.

In the case where the image to be processed is an image to be subjected to inter processing, inter prediction mode information, reference frame information, and motion vector information are supplied from the lossless decoder 112 to the motion predictor/compensator 122.

In step S174, the motion predictor/compensator 122 obtains information including prediction mode information. More specifically, inter prediction mode information, reference frame information, motion vector information, and weighted prediction flag information are obtained. The obtained motion vector information and inter prediction mode information are accumulated in the prediction mode/motion vector buffer 132. The weighted prediction flag information is accumulated per slice in the weighted prediction flag buffer 131.

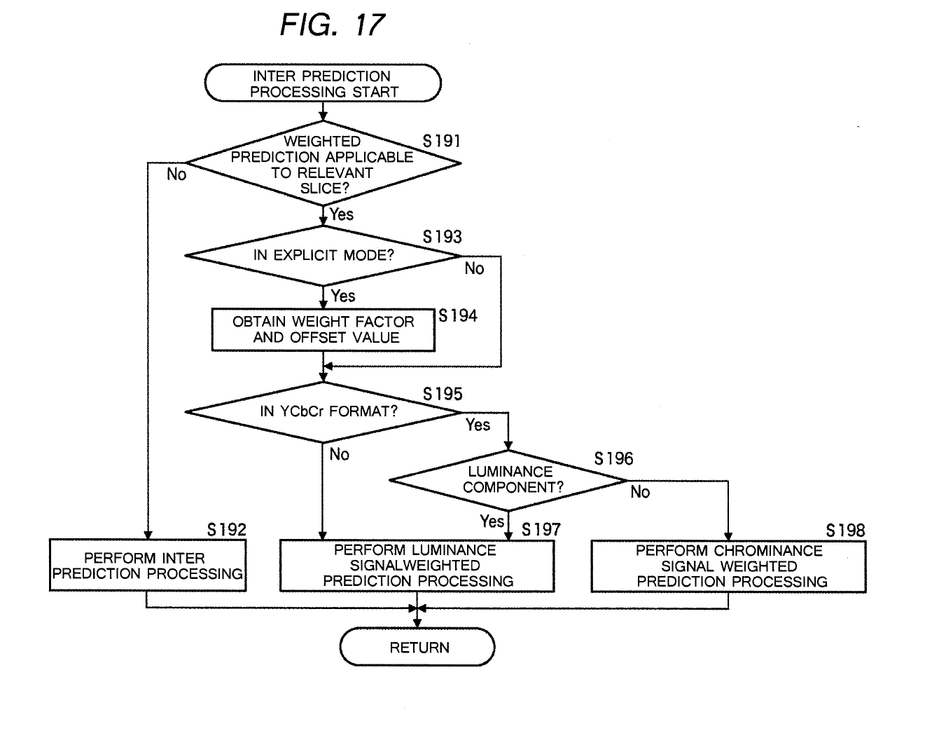

In step S175, the motion predictor/compensator 122 and the weighted predictor 123 perform inter prediction processing. The inter prediction processing is described later with reference to FIG. 17. Through the process of step S175, inter prediction images are generated and outputted to the switch 124.

### Description of Inter Prediction Processing of Image Decoding Apparatus

Description is given next of the inter prediction processing in step S175 of FIG. 16 with reference to the flowchart of FIG. 17.

The weighted prediction flag information accumulated in the weighted prediction flag buffer 131 is supplied to the motion compensator 133.

In step S191, the motion compensator 133 determines whether or not weighted prediction be applied to the relevant slice. In the case where determination is made that weighted prediction is not applied in step S191, the processing proceeds to step S192.

In step S192, the motion compensator 133 performs inter prediction processing that does not involve weighted prediction and is based on H.264/AVC standard. Specifically, the motion compensator 133 uses prediction modes and motion vector information from the prediction mode/motion vector buffer 132 to perform compensation processing on reference images from the frame memory 119, so as to generate prediction images. The generated prediction images are outputted to the switch 124.

In the case where determination is made that weighted prediction is applied in step S191, the processing proceeds to step S193.

In step S193, the weighted prediction flag buffer 131 references weighted prediction flag information and determines whether or not the mode is Explicit Mode. In the case where Explicit Mode is determined in step S193, the processing proceeds to step S194.

In this case, since the weighted prediction flag buffer 131 supplies the control signals to the weight/offset buffer 141, the weight/offset buffer 141 obtains weight factors and offset values to be supplied from the lossless decoder 112 for accumulation therein, in step S194.

Meanwhile, in the case where not Explicit Mode but Implicit Mode is determined, step S194 is skipped and the processing proceeds to step S195. Specifically, in this case, weight factors are calculated according to the equation (10) and accumulated at the weight factor calculator 142.

In step S195, the motion compensator 133 determines whether or not the format of the prediction images (reference images) to be generated is YCbCr format. In the case where YCbCr format is determined in step S195, the processing proceeds to step S196.

In step S196, the motion compensator 133 determines whether the prediction images to be generated are luminance components. In the case where luminance components are determined in step S196, the motion compensator 133 outputs the reference images (luminance components) to the luminance weighted motion compensator 143 and the processing proceeds to step S197.

In the case where not YCbCr format but RGB format is determined in step S195, the processing also proceeds to step S197. In other words, in this case, regardless of whether the prediction images to be generated are luminance components or chrominance components, the luminance weighted motion compensator 143 receives outputs, and the process of step S197 is performed.

In step S197, the luminance weighted motion compensator 143 performs weighted prediction for the luminance signal. More specifically, the luminance weighted motion compensator 143 uses weight factors (and offset values) from the weight/offset buffer 141 or the weight factor calculator 142, i.e., the equation (1) or (2)) to perform weighted prediction processing on the luminance signals or the chrominance signals (in the case of RGB), so as to generate prediction image pixel values. In other words, in this case, weighed prediction based on H.264/AVC standard is performed. The generated prediction image pixel values are outputted to the motion compensator 133.

Meanwhile, in the case where not luminance components but chrominance components are determined in step S196, the processing proceeds to step S198.

In step S198, the chrominance weighted motion compensator 144 performs weighted prediction for the chrominance signal. More specifically, the chrominance weighted motion compensator 144 uses weight factors (and offset values) from the weight/offset buffer 141 or the weight factor calculator 142, i.e., the equation (13) or (14)), to perform weighted prediction processing on the chrominance signals (in the case of YCbCr), so as to generate prediction image pixel values. The generated prediction image pixel values are outputted to the motion compensator 133.

As descried above, in the image coding apparatus 51 and the image decoding apparatus 101, weighted prediction methods are switched between the luminance signal and the chrominance signal in the case where the input signal is in YCbCr format. For example, weighted prediction for the chrominance signal is performed such that, as represented by the equations (13) and (14), 2ⁿ⁻¹ is subtracted in multiplication and 2ⁿ⁻¹ is added after that.

In this manner, weighted prediction of chrominance signals is implemented while obviating lowering of prediction efficiency.

In the foregoing, description is exemplarily made of the case where the size of the macroblock is 16×16 pixels; however, the present invention is applicable to the extended macroblock sizes described in the above-described Non-patent Document 2.

### Description of Application to Extended Macroblock Size

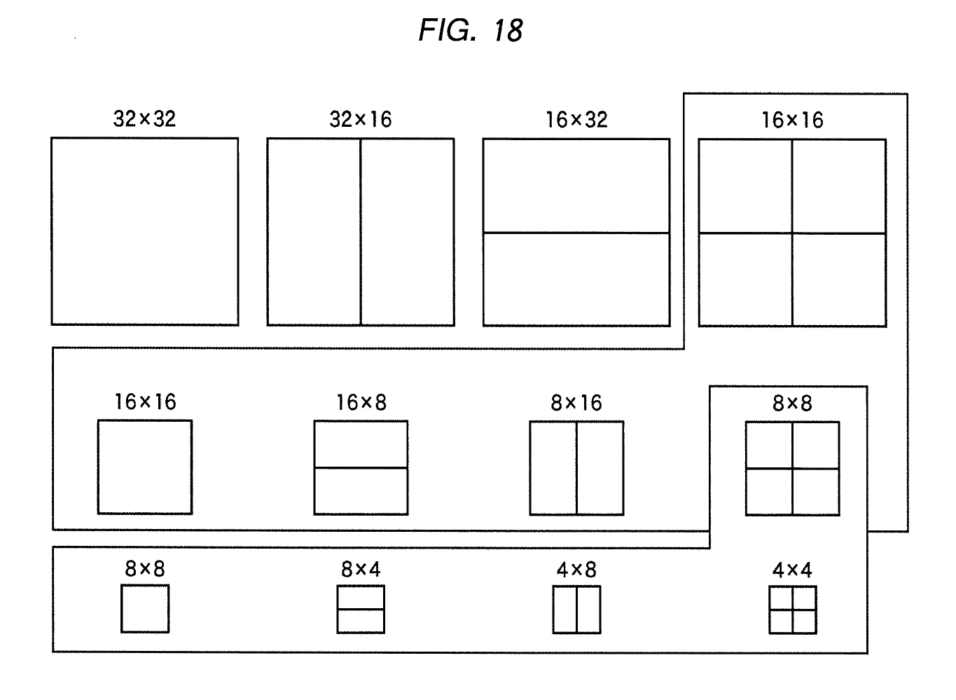

FIG. 18 depicts the exemplary block sizes proposed in Non-patent Document 2. In Non-patent Document 2, the macroblock size is extended to 32×32 pixels.

In the upper row of FIG. 18, macroblocks comprising 32×32 pixels are depicted in order from the left, each macroblock being divided into the blocks (partitions) of 32×32 pixels, 32×16 pixels, 16×32 pixels, and 16×16 pixels. In the middle row of FIG. 18, blocks comprising 16×16 pixels are depicted in order from the left, each block being divided into the blocks of 16×16 pixels, 16×8 pixels, 8×16 pixels, and 8×8 pixels. In the lower row of FIG. 18, blocks comprising 8×8 pixels are depicted in order from the left, each block being divided into the blocks of 8×8 pixels, 8×4 pixels, 4×8 pixels, and 4×4 pixels.

In other words, the macroblock of 32×32 pixels is processable in the blocks of 32×32 pixels, 32×16 pixels, 16×32 pixels, and 16×16 pixels that are depicted in the upper row of FIG. 18.

The 16×16 pixel block depicted on the right of the upper row is processable, as in the case of H.264/AVC standard, in the blocks of 16×16 pixels, 16×8 pixels, 8×16 pixels, and 8×8 pixels that are depicted in the middle row.

The 8×8 pixel block depicted on the right of the middle row is processable, as in the case of H.264/AVC standard, in the blocks of 8×8 pixels, 8×4 pixels, 4×8 pixels, and 4×4 pixels that are depicted in the lower row.

These blocks are categorized into the following three hierarchies: A first hierarchy refers to the blocks of 32×32 pixels, 32×16 pixels, and 16×32 pixels depicted in the upper row of FIG. 18; a second hierarchy refers to the blocks of 16×16 pixels depicted on the right in the upper row, and 16×16 pixels, 16×8 pixels, and 8×16 pixels that are depicted in the middle row; and a third hierarchy refers to the blocks of 8×8 pixels depicted on the right in the middle row, and 8×8 pixels, 8×4 pixels, 4×8 pixels, and 4×4 pixels that are depicted in the lower row.

According to the proposal of Non-patent Document 2, adopting of such a hierarchical structure ensures scalability with H.264/AVC standard for 16×16 pixel blocks or smaller, while defining larger blocks as supersets thereof.

The present invention is applicable to such extended macroblock sizes thus proposed.

Incidentally, standardization of a coding standard referred to as HEVC (High Efficiency Video Coding) is currently pursued by the JCTVC (Joint Collaboration Team-Video Coding), which is a joint standardization group of ITU-T and ISO/IEC aiming at further improvement in coding efficiency over AVC. As of September, 2010, “Test Model under Consideration”, (JCTVC-B205) has been issued as a draft.

Description is given of the Coding Unit defined in HEVC coding standard.

The Coding Unit (CU), which is also called the Coding Tree Block (CTB), plays a similar role to the macroblock in AVC; only, while the latter is fixed to the size of 16×16 pixels, the size of the former is not fixed, such that the size is to be specified in image compression information on the sequence basis.

Especially, the CU with the largest size is referred to as LCU (Largest Coding Unit), and the CU with the smallest size is referred to as SCU (Smallest Coding Unit). These sizes are to be specified in sequence parameter sets contained in image compression information; the sizes are limited to sizes that are representable by the square and powers of two.

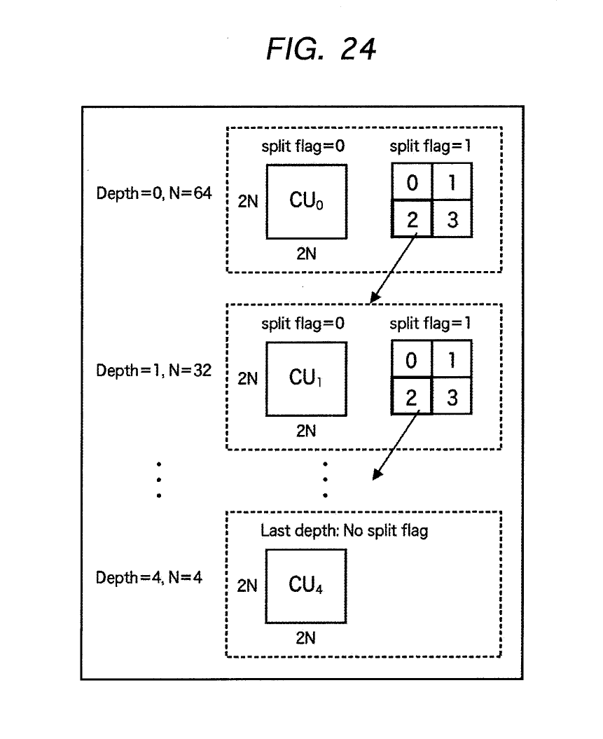

An exemplary Coding Unit defined in HEVC is depicted in FIG. 24. In the example depicted in the figure, the LCU has a size of 128, and the maximum depth for UC hierarchy is 5. In the case where split_flag has a value of 1, a CU with a size of 2N×2N is divided into CUs with a size of N×N, which is lower by one hierarchy.

Further, the CU is dividable into the Prediction Unit (PU), which is the unit for intra/inter prediction and also dividable into the Transform Unit (TU), which is the unit for the orthogonal transform.

The Coding Units are further dividable into PUs (Prediction Units), which are the unit for intra/inter prediction and also dividable into TUs (Transform Units), which are the unit for the orthogonal transform, so as to be subjected to prediction processing and orthogonal transform processing. Currently according to HEVC, in addition to 4×4 and 8×8, 16×16 and 32×32 orthogonal transforms are employable.

The blocks and macroblocks herein encompass the concepts of the Coding Unit (CU), the Prediction Unit (PU), and the Transform Unit (TU) as described above and are not limited to the blocks with fixed sizes.

In the foregoing description, H.264/AVC standard is basically used as the coding standard; however, the present invention is not limited thereto and is applicable to other coding standards/decoding standards for performing weighted prediction with image signals in YCbCr format as the inputs thereof.

It is to be noted that the present invention is applicable to image coding apparatuses and image decoding apparatuses for use in receiving image information (bitstreams) that is compressed by orthogonal transform, such as discrete cosine transform, and motion compensation, through network media, such as satellite broadcasting, cable television, the Internet, or mobile phones, according to, for example, MPEG and H.26x. Further, the present invention is applicable to image coding apparatuses and image decoding apparatuses for use in performing processing on storage media such as optical disks, magnetic disks, and flash memories. Moreover, the present invention is applicable to motion prediction/compensation apparatuses included in those image coding apparatuses and image decoding apparatuses.

The series of processes described above are executable either by hardware or software. In the case of executing the series of processes by software, programs configuring the software are installed on a computer. Herein, exemplary computers include computers that are built in dedicated hardware and general-purpose personal computers configured to execute various functions on installation of various programs.

### Configuration Example of Personal Computer

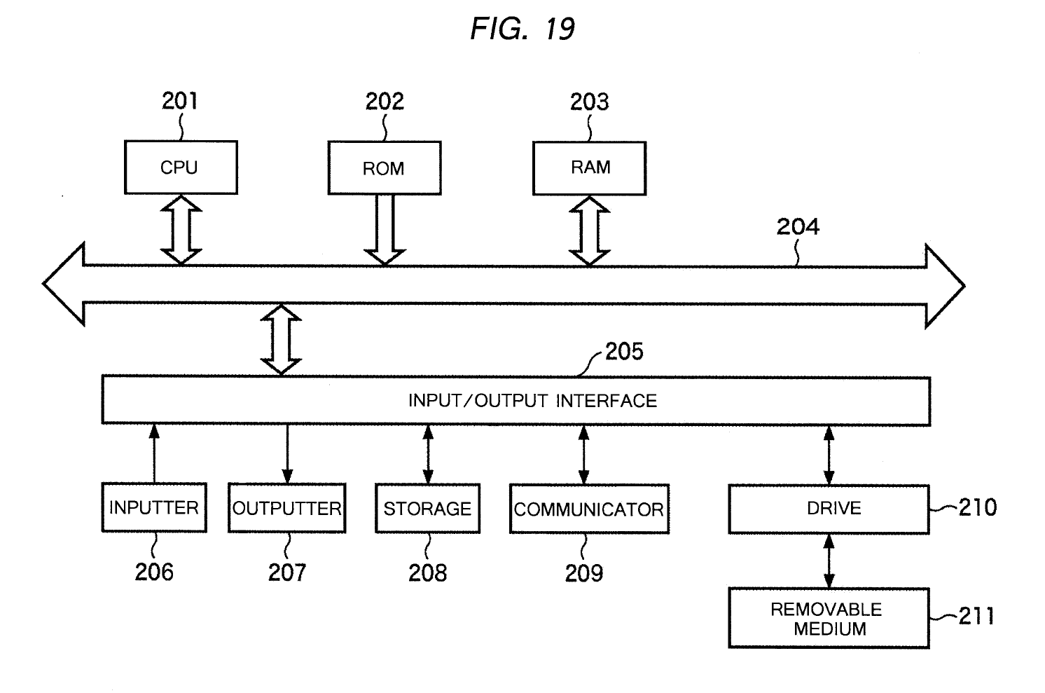

FIG. 19 is a block diagram depicting a configuration example of the hardware of a computer for executing the above-described series of processes based on a program.

In the computer, a CPU (Central Processing Unit) 201, a ROM (Read Only Memory) 202, and a RAM (Random Access Memory) 203 are coupled to one another by a bus 204.

The bus 204 is further connected with an input/output interface 205. To the input/output interface 205 are connected with an inputter 206, an outputter 207, a storage 208, a communicator 209, and a drive 210.

The inputter 206 includes a keyboard, a mouse, and a microphone. The outputter 207 includes a display and a speaker. The storage 208 includes a hard disk and a nonvolatile memory. The communicator 209 includes a network interface. The drive 210 drives a removable medium 211 such as a magnetic disk, an optical disk, a magnetoptical disk, or a semiconductor memory.

In the computer thus configured, the CPU 201 executes a program that is stored on, for example, the storage 208 by having the program loaded on the RAM 203 through the input/output interface 205 and the bus 204, such that the above-described series of processes is performed.

The program to be executed by the computer (CPU 201) may be provided in the form of the removable medium 211 as, for example, a package medium recording the program. The program may also be provided through a wired or radio transmission medium such as Local Area Network, the Internet, or digital broadcasting.

In the computer, the program may be installed on the storage 208 through the input/output interface 205 with the removable medium 211 attached to the drive 210. The program may also be received through a wired or radio transmission medium at the communicator 209 for installation on the storage 208. Otherwise, the program may be installed on the ROM 202 or the storage 208 in advance.

The program to be executed by the computer may be a program by which the processes are performed in time sequence according to the order described herein, or alternatively, may be a program by which processes are performed at an appropriately timing, e.g., in parallel or when a call is made.

Embodiments of the present invention are not limited to the foregoing embodiments, and various changes and modifications can be made without departing from the scope of the present invention.

For example, the above-described image coding apparatus 51 and the image decoding apparatus 101 are applicable to any electronics. Examples thereof are described hereinafter.

### Configuration Example of Television Receiver

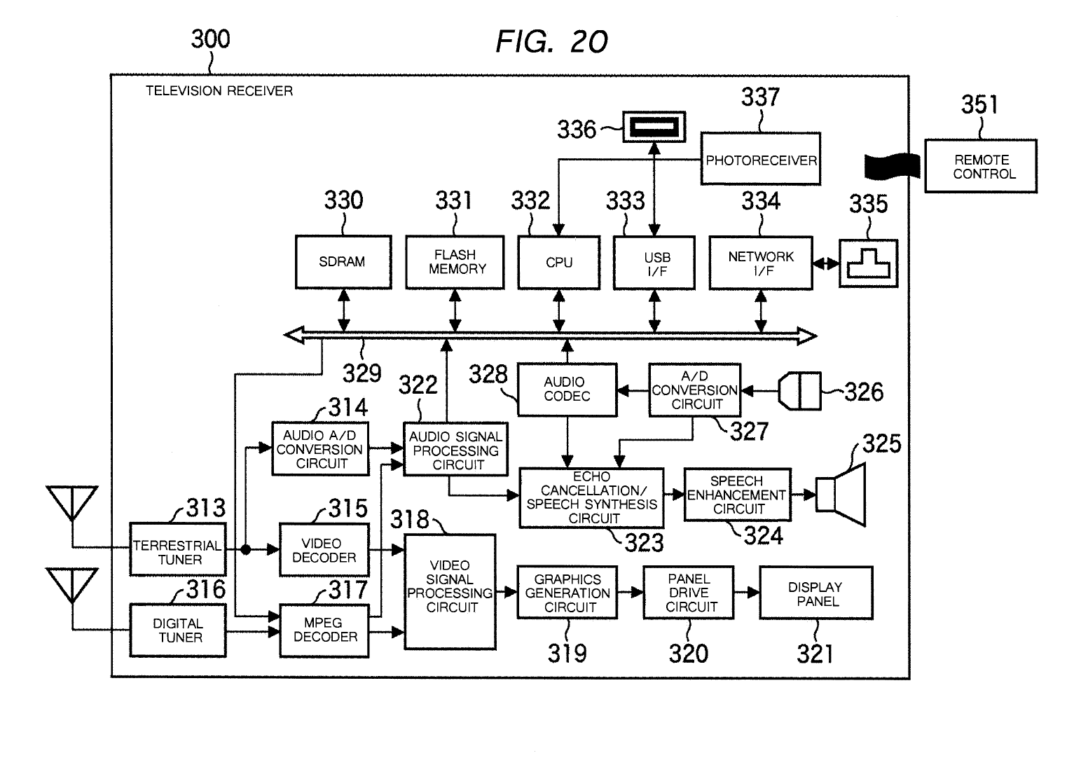

FIG. 20 is a block diagram depicting a main configuration example of a television receiver using an image decoding apparatus to which the present invention is applied.

A television receiver 300 depicted in FIG. 20 includes a terrestrial tuner 313, a video decoder 315, a video signal processing circuit 318, a graphics generation circuit 319, a panel drive circuit 320, and a display panel 321.

The terrestrial tuner 313 receives broadcast wave signals for terrestrial analog broadcasting through an antenna, demodulates them to obtain video signals, and supplies the signals to the video decoder 315. The video decoder 315 performs decoding processing on the video signals supplied from the terrestrial tuner 313 and supplies the resultant digital component signals to the video signal processing circuit 318.

The video signal processing circuit 318 performs predetermined processing such as noise reduction on the video data supplied from the video decoder 315 and supplies the resultant video data to the graphics generation circuit 319.

The graphics generation circuit 319 generates, for example, video data for broadcasts to be displayed on the display panel 321 and image data obtainable upon processing based on an application to be supplied over a network, so as to supply the generated video data and image data to the panel drive circuit 320. In addition, the graphics generation circuit 319 appropriately performs processing, such as generating video data (graphics) to be used for displaying a screen for use by a user upon selection of an item and supplying to the panel drive circuit 320 video data obtainable, for example, through superimposition on the video data of a broadcast.

The panel drive circuit 320 drives the display panel 321 based on the data supplied from the graphics generation circuit 319 and causes the display panel 321 to display thereon video of broadcasts and various screens as described above.

The display panel 321 includes an LCD (Liquid Crystal Display) and is adapted to display video of broadcasts under the control of the panel drive circuit 320.

Further, the television receiver 300 also includes an audio A/D (Analog/Digital) conversion circuit 314, an audio signal processing circuit 322, an echo cancellation/speech synthesis circuit 323, a speech enhancement circuit 324, and a speaker 325.

The terrestrial tuner 313 demodulates the received broadcast wave signals so as to obtain not only video signals but also audio signals. The terrestrial tuner 313 supplies the obtained audio signals to the audio A/D conversion circuit 314.

The audio A/D conversion circuit 314 performs AM conversion processing on the audio signals supplied from the terrestrial tuner 313 and supplies the resultant digital audio signals to the audio signal processing circuit 322.

The audio signal processing circuit 322 performs predetermined processing such as noise reduction on the audio data supplied from the audio A/D conversion circuit 314 and supplies the resultant audio data to the echo cancellation/speech synthesis circuit 323.

The echo cancellation/speech synthesis circuit 323 supplies the audio data supplied from the audio signal processing circuit 322 to the speech enhancement circuit 324.

The speech enhancement circuit 324 performs D/A conversion processing and amplification processing on the audio data supplied from the echo cancellation/speech synthesis circuit 323 and then makes adjustment to a specific sound volume, so as to cause the speaker 325 to output the audio.

Further, the television receiver 300 includes a digital tuner 316 and an MPEG decoder 317.

The digital tuner 316 receives broadcast wave signals for digital broadcasting (terrestrial digital broadcasting and BS (Broadcasting Satellite)/CS (Communications Satellite) digital broadcasting) through an antenna, demodulates the signals, and obtains MPEG-TSs (Moving Picture Experts Group-Transport Streams), for supply to the MPEG decoder 317.

The MPEG decoder 317 performs unscrambling on the MPEG-TSs supplied from the digital tuner 316, so as to extract a stream containing data of a broadcast to be played (viewed.) The MPEG decoder 317 decodes audio packets constructing the extracted stream and supplies the resultant audio data to the audio signal processing circuit 322, while decoding video packets constructing the stream to supply the resultant video data to the video signal processing circuit 318. Further, the MPEG decoder 317 supplies EPG (Electronic Program Guide) data extracted from the MPEG-TSs through a path (not shown) to the CPU 332.

The television receiver 300 thus uses the above-described image decoding apparatus 101 in the form of the MPEG decoder 317 for decoding video packets. Hence, the MPEG decoder 317 allows for, as in the case of the image decoding apparatus 101, improvement in prediction efficiency in weighted prediction for chrominance signals.

The video data supplied from the MPEG decoder 317 is, as in the case of the video data supplied from the video decoder 315, is subjected to predetermined processing at the video signal processing circuit 318. Then, the video data performed with the predetermined processing is appropriately superimposed at the graphics generation circuit 319 with, for example, video data generated, and is supplied through the panel drive circuit 320 to the display panel 321, such that the images are displayed thereon.

The audio data supplied from the MPEG decoder 317 is, as in the case of the audio data supplied from the audio A/D conversion circuit 314, subjected to predetermined processing at the audio signal processing circuit 322. Then, the audio data performed with the predetermined processing is supplied through the echo cancellation/speech synthesis circuit 323 to the speech enhancement circuit 324 to be subjected to D/A conversion processing and amplification processing. As a result, audio adjusted to a specific sound volume is outputted from the speaker 325.

The television receiver 300 also includes a microphone 326 and an A/D conversion circuit 327.

The A/D conversion circuit 327 receives speech signals of users to be taken by the microphone 326 that is provided in the television receiver 300 for use in speech conversation. The A/D conversion circuit 327 performs A/D conversion processing on the speech signals received and supplies the resultant digital speech data to the echo cancellation/speech synthesis circuit 323.

The echo cancellation/speech synthesis circuit 323 performs, in the case where speech data of a user (a user A) of the television receiver 300 is supplied from the A/D conversion circuit 327, echo cancellation on the speech data of the user A. Then, the echo cancellation/speech synthesis circuit 323 causes the speaker 325, through the speech enhancement circuit 324, to output the speech data that results from echo cancellation followed by, for example, synthesis with other speech data.

The television receiver 300 further includes an audio codec 328, an internal bus 329, an SDRAM (Synchronous Dynamic Random Access Memory) 330, a flash memory 331, a CPU 332, a USB (Universal Serial Bus) I/F 333, and a network I/F 334.

The A/D conversion circuit 327 receives speech signals of users taken by the microphone 326 that is provided in the television receiver 300 for use in speech conversation. The A/D conversion circuit 327 performs A/D conversion processing on the speech signals received and supplies the resultant digital speech data to the audio codec 328.

The audio codec 328 converts the speech data supplied from the A/D conversion circuit 327 into data in a predetermined format for transmission via a network and supplies the data through the internal bus 329 to the network I/F 334.

The network I/F 334 is connected to a network by means of a cable attached to a network terminal 335. The network I/F 334 transmits the speech data supplied from the audio codec 328 to, for example, another apparatus to be connected to the network. Further, the network I/F 334 receives through the network terminal 335 speech data to be transmitted from, for example, another apparatus to be connected through the network, so as to supply the data through the internal bus 329 to the audio codec 328.

The audio codec 328 converts the speech data supplied from the network I/F 334 into data in a predetermined format and supplies the data to the echo cancellation/speech synthesis circuit 323.

The echo cancellation/speech synthesis circuit 323 performs echo cancellation on the speech data to be supplied from the audio codec 328 and causes, through the speech enhancement circuit 324, the speaker 325 to output the speech data that results from, for example, synthesis with other speech data.

The SDRAM 330 stores various kinds of data to be used by the CPU 332 for processing.

The flash memory 331 stores programs to be executed by the CPU 332. The programs stored on the flash memory 331 are read by the CPU 332 at a specific timing such as upon boot of the television receiver 300. The flash memory 331 also stores data including EPG data that has been obtained via digital broadcasting and data that has been obtained from a specific server over a network.

For example, stored on the flash memory 331 is MPEG-TSs containing content data obtained from a specific server over a network under the control of the CPU 332. The flash memory 331 supplies the MPEG-TSs through the internal bus 329 to the MPEG decoder 317, for example, under the control of the CPU 332.

The MPEG decoder 317 processes, as in the case of the MPEG-TSs supplied from the digital tuner 316, the MPEG-TSs. In this manner, the television receiver 300 is configured to receive content data including video, audio, and other information, over networks, to perform decoding by using the MPEG decoder 317, and to provide the video for display or the audio for output.

The television receiver 300 further includes a photoreceiver 337 for receiving infrared signals to be transmitted from a remote control 351.

The photoreceiver 337 receives infrared signals from the remote control 351 and outputs to the CPU 332 control codes indicating the content of the user operation that has been obtained through demodulation.

The CPU 332 executes programs stored on the flash memory 331 and conducts control over the overall operation of the television receiver 300 according to, for example, the control codes to be supplied from the photoreceiver 337. The CPU 332 and the constituent portions of the television receiver 300 are connected through paths (not shown).

The USB I/F 333 performs data transmission/reception with an external instrument of the television receiver 300, the instrument to be connected by means of a USB cable attached to a USB terminal 336. The network I/F 334 is connected to a network by means of a cable attached to the network terminal 335 and is adapted to perform transmission/reception of data other than audio data with various apparatuses to be connected to the network.

The television receiver 300 allows for improvement in coding efficiency by the use of the image decoding apparatus 101 in the form of the MPEG decoder 317. As a result, the television receiver 300 is capable of obtaining and rendering finer decoded images based on broadcast wave signals receivable through an antenna and content data obtainable over networks.

### Configuration Example of Mobile Phone

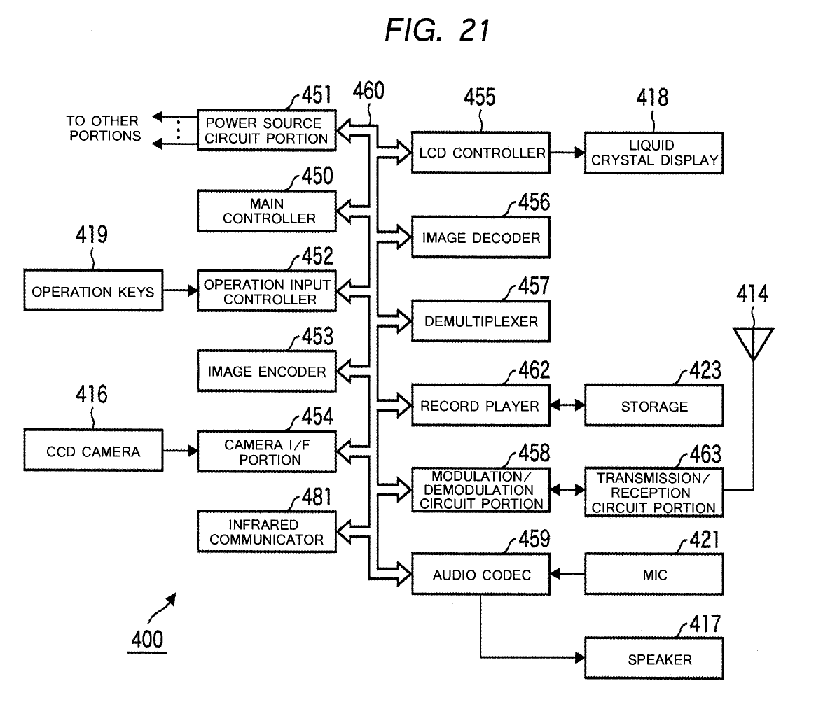

FIG. 21 is a block diagram depicting a main configuration example of a mobile phone using an image coding apparatus and an image decoding apparatus to which the present invention is applied.

A mobile phone 400 depicted in FIG. 21 includes a main controller 450 that is configured to perform overall control over the constituent portions, a power source circuit portion 451, an operation input controller 452, an image encoder 453, a camera I/F portion 454, an LCD controller 455, an image decoder 456, a demultiplexer 457, a record player 462, a modulation/demodulation circuit portion 458, and an audio codec 459. These portions are coupled to one another by a bus 460.

The mobile phone 400 also includes operation keys 419, a CCD (Charge Coupled Devices) camera 416, a liquid crystal display 418, a storage 423, a transmission/reception circuit portion 463, an antenna 414, a microphone (mic) 421, and a speaker 417.

The power source circuit portion 451 supplies power to the constituent portions from a battery pack when a call-end-and-power-on key is switched on by a user operation, so as to activate the mobile phone 400 into an operable condition.

The mobile phone 400 performs various operations including transmission/reception of speech signals, transmission/reception of emails and image data, image photographing, and data recording in various modes, such as a voice call mode and a data communication mode, under the control of the main controller 450 configured by, for example, a CPU, a ROM, and a RAM.

For example, in the voice call mode, the mobile phone 400 converts speech signals collected by the microphone (mic) 421 to digital speech data by the audio codec 459 and performs spread spectrum processing at the modulation/demodulation circuit portion 458, for digital/analog conversion processing and frequency conversion processing at the transmission/reception circuit portion 463. The mobile phone 400 transmits the transmitting signals obtained by the conversion processing, through the antenna 414 to a base station (not shown). The transmitting signals (speech signals) transmitted to the base station are supplied over a public telecommunication line to a mobile phone of a call recipient.

Also, for example, in the voice call mode, the mobile phone 400 amplifies at the transmission/reception circuit portion 463 the reception signals that have been received through the antenna 414, further performs frequency conversion processing and analog/digital conversion processing, performs spread spectrum processing at the modulation/demodulation circuit portion 458, and converts the signals to analog speech signals by the audio codec 459. The mobile phone 400 outputs from the speaker 417 the analog speech signals thus obtained through the conversion.

Further, for example, in the case of transmitting emails in the data communication mode, the mobile phone 400 receives, at the operation input controller 452, text data of an email that has been inputted through operation on the operation keys 419. The mobile phone 400 processes the text data at the main controller 450 so as to cause through LCD controller 455 the liquid crystal display 418 to display the data as images.

The mobile phone 400 also generates at the main controller 450 email data based on, for example, the text data and the user instruction received at the operation input controller 452. The mobile phone 400 performs spread spectrum processing on the email data at the modulation/demodulation circuit portion 458 and performs digital/analog conversion processing and frequency conversion processing at the transmission/reception circuit portion 463. The mobile phone 400 transmits the transmitting signals that result from the conversion processing, through the antenna 414 to a base station (not shown). The transmitting signals (emails) that have been transmitted to the base station are supplied to prescribed addresses, for example, over networks and through mail servers.

For example, in the case of receiving emails in the data communication mode, the mobile phone 400 receives through the antenna 414 at the transmission/reception circuit portion 463 signals that have been transmitted from the base station, amplifies the signals, and further performs frequency conversion processing and analog/digital conversion processing. The mobile phone 400 restores original email data through inverse spread spectrum processing at the modulation/demodulation circuit portion 458. The mobile phone 400 causes through the LCD controller 455 the liquid crystal display 418 to display the restored email data.

It is to be noted that the mobile phone 400 may cause through the record player 462 the storage 423 to record (store) the received email data.

The storage 423 is a rewritable storage medium in any form. The storage 423 may, for example, a semiconductor memory such as a RAM or a built-in flash memory, a hard disk, or a removable medium such as a magnetic disk, a magnetoptical disk, an optical disk, a USB memory, or a memory card. Apparently, other storage media may appropriately used.

Further, for example, in the case of transmitting image data in the data communication mode, the mobile phone 400 generates image data by photographing with the CCD camera 416. The CCD camera 416 has an optical device such as a lens and a diaphragm and a CCD serving as a photoelectric conversion device and is adapted to photograph a subject, to convert the intensity of the received light to electrical signals, and to generate image data of an image of the subject. The image data is compressed and encoded through the camera I/F portion 454 at the image encoder 453 according to a predetermined coding standard such as MPEG-2 or MPEG-4, so as to convert the data into encoded image data.

The mobile phone 400 uses the above-described image coding apparatus 51 in the form of the image encoder 453 for performing such processing. Hence, the image encoder 453 achieves, as in the case of the image coding apparatus 51, improvement in prediction efficiency in weighted prediction for chrominance signals.

The mobile phone 400 performs, at the audio codec 459, analog/digital conversion on the speech collected by the microphone (mic) 421 simultaneously with photographing by the CCD camera 416 and further performs encoding thereon.

The mobile phone 400 multiplexes at the demultiplexer 457 the encoded image data supplied from the image encoder 453 and the digital speech data supplied from the audio codec 459 according to a predetermined standard. The mobile phone 400 performs spread spectrum processing on the resultant multiplexed data at the modulation/demodulation circuit portion 458 and then subjects the data to digital/analog conversion processing and frequency conversion processing at the transmission/reception circuit portion 463. The mobile phone 400 transmits the transmitting signals that result from the conversion processing, through the antenna 414 to a base station (not shown.) The transmitting signals (image data) that have been transmitted to the base station are supplied to a call recipient over, for example, a network.

In the case where the image data is not transmitted, the mobile phone 400 may cause not through the image encoder 453 but through the LCD controller 455 the liquid crystal display 418 to display the image data generated at the CCD camera 416.

Further, for example, in the case of receiving data of dynamic picture files that are linked to, for example, a simplified website in the data communication mode, the mobile phone 400 receives at the transmission/reception circuit portion 463 through the antenna 414 signals transmitted from the base station, amplifies the signals, and further performs frequency conversion processing and analog/digital conversion processing. The mobile phone 400 performs inverse spread spectrum processing on the received signals at the modulation/demodulation circuit portion 458 to restore the original multiplexed data. The mobile phone 400 separates the multiplexed data at the demultiplexer 457 to split the data into encoded image data and speech data.

The mobile phone 400 decodes at the image decoder 456 the encoded image data according to a decoding standard corresponding to a predetermined coding standard such as MPEG-2 or MPEG-4 to generate the dynamic picture data to be replayed, and causes, through the LCD controller 455, the liquid crystal display 418 to display the data thereon. In this manner, for example, moving picture data contained in dynamic picture files linked to a simplified website is displayed on the liquid crystal display 418.

The mobile phone 400 uses the above-described image decoding apparatus 101 in the form of the image decoder 456 for performing such processing. Hence, the image decoder 456 achieves, as in the case of the image decoding apparatus 101, improvement in prediction efficiency in weighted prediction for chrominance signals.

At this time, the mobile phone 400 converts digital audio data to analog audio signals at the audio codec 459 and causes the speaker 417 to output the signals at the same timing. Thus, for example, audio data contained in dynamic picture files that are linked to a simplified website is replayed.

It is to be noted that, as in the case of emails, the mobile phone 400 may cause through the record player 462 the storage 423 to record (store) the received data that is linked to, for example, simplified websites.

The mobile phone 400 may also analyze, at the main controller 450, binary codes that have been obtained at the CCD camera 416 by photographing and obtain the information that is recorded in the binary codes.

Further, the mobile phone 400 may perform infrared communication with an external device at an infrared communicator 481.

The mobile phone 400 uses the image coding apparatus 51 in the form of the image encoder 453, so that improvement in coding efficiency is achieved. As a result, the mobile phone 400 is capable of providing encoded data (image data) with good coding efficiency to other apparatuses.

And besides, the mobile phone 400 uses the image decoding apparatus 101 in the form of the image decoder 456, so that improvement in coding efficiency is achieved. As a result, the mobile phone 400 is capable of obtaining and displaying finer decoded images from, for example, dynamic picture files that are linked to simplified websites.

In the foregoing description, the mobile phone 400 uses the CCD camera 416; instead of the CCD camera 416, an image sensor using a CMOS (Complementary Metal Oxide Semiconductor) (CMOS image sensor) may also be used. In this case also, the mobile phone 400 is capable of, as in the case of using the CCD camera 416, photographing a subject and generating image data of the images of the subject.

In the foregoing description, the mobile phone 400 is exemplarily illustrated; however, the image coding apparatus 51 and the image decoding apparatus 101 are applicable as in the case of the mobile phone 400 to any apparatus that has a photographing function and/or communication function similar to those of the mobile phone 400, such as PDAs (Personal Digital Assistants), smart phones, UMPCs (Ultra Mobile Personal Computers), netbooks, and laptop personal computers.

### Configuration Example of Hard Disk Recorder

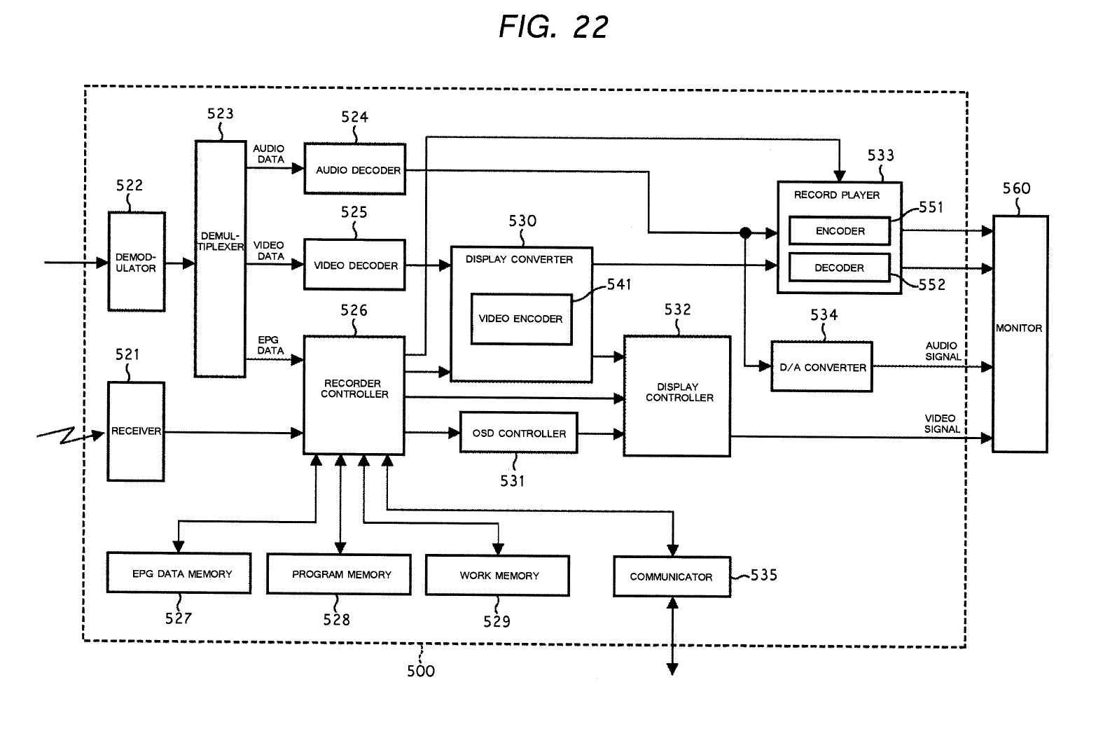

FIG. 22 is a block diagram depicting a main configuration example of a hard disk recorder using an image coding apparatus and an image decoding apparatus to which the present invention is applied.

A hard disk recorder (HDD recorder) 500 depicted in FIG. 22 is an apparatus for holding on a build-in hard disk audio data and video data of broadcasts contained in broadcast wave signals (television signals) to be transmitted from, for example, satellites or through terrestrial antennas and received from a tuner, so as to provide the held data to users at a timing in response to user instructions.

For example, the hard disk recorder 500 is configured to extract audio data and video data from broadcast wave signals and to decode the data suitably for storage on the built-in hard disk. The hard disk recorder 500 may also obtain audio data and video data from another apparatus over, for example, a network and decode the data suitably for storage on the built-in hard disk.

Further, for example, the hard disk recorder 500 is configured to decode audio data and/or video data that has been recorded on the built-in hard disk and to supply the decoded data to a monitor 560, so as to cause the monitor 560 to display the images on the screen thereof. In addition, the hard disk recorder 500 is configured to output the audio from a speaker of the monitor 560.

For example, the hard disk recorder 500 decodes audio data and video data extracted from broadcast wave signals obtained through a tuner, or audio data and video data obtained from another apparatus over a network and supplies the decoded data to the monitor 560, so as to cause the monitor 560 to display the images on the screen thereof. The hard disk recorder 500 may also cause a speaker of the monitor 560 to output the audio.

Apparently, other operations are also possible.

As depicted in FIG. 22, the hard disk recorder 500 includes a receiver 521, a demodulator 522, a demultiplexer 523, an audio decoder 524, a video decoder 525, and a recorder controller 526. The hard disk recorder 500 further includes an EPG data memory 527, a program memory 528, a work memory 529, a display converter 530, and an OSD (On Screen Display) controller 531, a display controller 532, a record player 533, a D/A converter 534, and a communicator 535.

In addition, the display converter 530 includes a video encoder 541. The record player 533 includes an encoder 551 and a decoder 552.

The receiver 521 receives infrared signals from a remote control (not shown) and converts the signals to electrical signals, so as to output the signals to the recorder controller 526. The recorder controller 526 is configured by, for example, a microprocessor and is adapted to execute various processes according to programs stored on the program memory 528. At this time, the recorder controller 526 uses the work memory 529 when needed.

The communicator 535 is connected to a network to perform communication with another apparatus over the network. For example, the communicator 535 communicates, under the control of the recorder controller 526, with a tuner (not shown), so as to output channel selection control signals mainly to the tuner.

The demodulator 522 demodulates signals supplied from the tuner and outputs the signals to the demultiplexer 523. The demultiplexer 523 separates the data supplied from the demodulator 522 into audio data, video data, and EPG data and outputs the pieces of data to the audio decoder 524, the video decoder 525, and/or the recorder controller 526, respectively.

The audio decoder 524 decodes the inputted audio data according to, for example, an MPEG standard and outputs the data to the record player 533. The video decoder 525 decodes the inputted video data according to, for example, an MPEG standard and outputs the data to the display converter 530. The recorder controller 526 supplies the inputted EPG data to the EPG data memory 527 and to have the memory store the data.

The display converter 530 encodes video data supplied from the video decoder 525 or the recorder controller 526 by using the video encoder 541 into video data according to, for example, an NTSC (National Television Standards Committee) standard and outputs the data to the record player 533. The display converter 530 also converts the size of the screen of video data to be supplied from the video decoder 525 or the recorder controller 526 into a size corresponding to the size of the monitor 560. The display converter 530 converts the video data with converted screen size further to video data according to an NTSC standard by using the video encoder 541 and converts the data into analog signals, so as to output the signals to the display controller 532.

The display controller 532 superimposes, under the control of the recorder controller 526, OSD signals outputted from the OSD (On Screen Display) controller 531 on video signals inputted from the display converter 530, so as to output the signals to the display of the monitor 560 for display.

The monitor 560 is also configured to be supplied with audio data that has been outputted from the audio decoder 524 and then been converted by the D/A converter 534 to analog signals. The monitor 560 outputs the audio signals from a built-in speaker.

The record player 533 includes a hard disk as a storage medium for recording data including video data and audio data.

For example, the record player 533 encodes audio data to be supplied from the audio decoder 524 according to an MPEG standard by using the encoder 551. The record player 533 also encodes video data to be supplied from the video encoder 541 of the display converter 530 according to an MPEG standard by using the encoder 551. The record player 533 synthesizes the encoded data of the audio data and the encoded data of the video data by means of a multiplexer. The record player 533 subjects the synthesized data to channel coding for amplification and writes the data on the hard disk by using a record head.

The record player 533 replays the data recorded on the hard disk by using a playhead, amplifies the data, and separates the data into audio data and video data by means of a demultiplexer. The record player 533 decodes the audio data and the video data by using the decoder 552 according to an MPEG standard. The record player 533 performs D/A conversion on the decoded audio data and outputs the data to the speaker of the monitor 560. The record player 533 also performs D/A conversion on the decoded video data and outputs the data to the display of the monitor 560.

The recorder controller 526 reads the latest EPG data from the EPG data memory 527 in response to a user instruction that is indicated by infrared signals to be received through the receiver 521 from the remote control and supplies the data to the OSD controller 531. The OSD controller 531 generates image data corresponding to the inputted EPG data and outputs the data to the display controller 532. The display controller 532 outputs the video data inputted from the OSD controller 531 to the display of the monitor 560 for display. In this manner, an EPG (electronic program guide) is displayed on the display of the monitor 560.

The hard disk recorder 500 may also obtain various kinds of data, such as video data, audio data, or EPG data, to be supplied from other apparatuses over a network, such as the Internet.

The communicator 535 obtains the encoded data of, for example, video data, audio data, and EPG data to be transmitted from other apparatuses over a network under the control of the recorder controller 526 and supplies the data to the recorder controller 526. For example, the recorder controller 526 supplies the obtained encoded data of video data and audio data to the record player 533 to cause the hard disk to store the data thereon. At this time, the recorder controller 526 and the record player 533 may also perform processing such as transcoding as needed.

The recorder controller 526 decodes the obtained encoded data of video data and audio data and supplies the resultant video data to the display converter 530. The display converter 530 processes, in the same manner with respect to the video data to be supplied from the video decoder 525, the video data supplied from the recorder controller 526 and supplies the data through the display controller 532 to the monitor 560, so as to have the images displayed thereon.

Further, it may be so configured that, in addition to the image display, the recorder controller 526 supplies the decoded audio data through the D/A converter 534 to the monitor 560 and causes the audio to be outputted from the speaker.

Further, the recorder controller 526 decodes the obtained encoded data of EPG data, and supplies the decoded EPG data to the EPG data memory 527.

The hard disk recorder 500 as described above uses the image decoding apparatus 101 in the form of the video decoder 525, the decoder 552, and a decoder built in the recorder controller 526. Hence, the video decoder 525, the decoder 552, and the decoder built in the recorder controller 526 achieve, as in the case of the image decoding apparatus 101, improvement in prediction efficiency in weighted prediction for chrominance signals.

Hence, the hard disk recorder 500 is capable of generating more precise prediction images. As a result, the hard disk recorder 500 is capable of, for example, obtaining finer decoded images from the encoded data of video data received through a tuner, the encoded data of video data read from a hard disk of the record player 533, and the encoded data of video data obtained over a network, such that the images are displayed on the monitor 560.

Moreover, the hard disk recorder 500 uses the image coding apparatus 51 in the form of the encoder 551. Hence, the encoder 551 achieves, as in the case of the image coding apparatus 51, improvement in prediction efficiency in weighted prediction for chrominance signals.

Hence, the hard disk recorder 500 allows for improvement in coding efficiency of encoded data to be recorded on hard disks. As a result, the hard disk recorder 500 enables use of storage areas of hard disks at a higher rate and efficiency.

In the foregoing, description is given of a case of the hard disk recorder 500 for recording video data and audio data on a hard disk; however, the recording medium may obviously take any form. For example, the image coding apparatus 51 and the image decoding apparatus 101 are applicable to, as in the case of the above-described hard disk recorder 500, recorders using recording media other than hard disks, such as flash memories, optical disks, or video tapes.

### Configuration Example of Camera

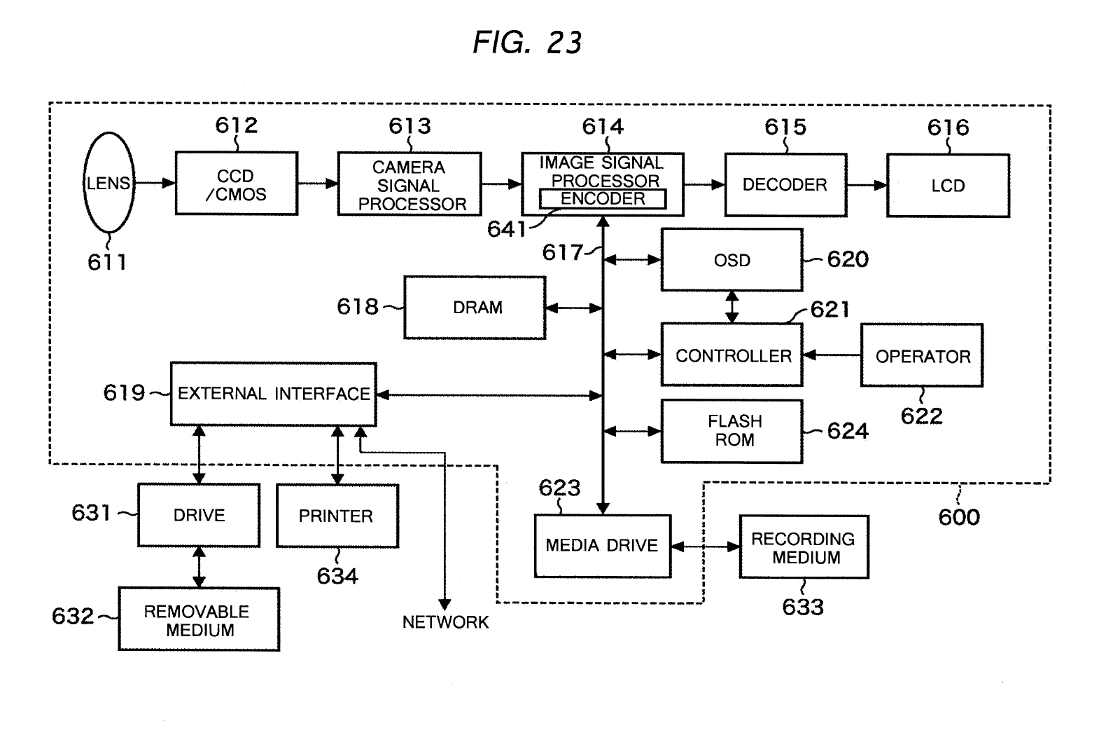

FIG. 23 is a block diagram depicting a main configuration example of a camera using an image decoding apparatus and an image coding apparatus to which the present invention is applied.

A camera 600 depicted in FIG. 23 is configured to photograph a subject, to cause the images of the subject to be displayed on an LCD 616, and to record the images on a recording medium 633 as image data.

A lens block 611 allows light (i.e., video of a subject) to be incident on a CCD/CMOS 612. The CCD/CMOS 612 is an image sensor using a CCD or a CMOS and is adapted to convert the intensity of the received light into electrical signals and to supply the signals to a camera signal processor 613.

The camera signal processor 613 converts the electrical signals supplied from the CCD/CMOS 612 to chrominance signals of Y, Cr, and Cb and supplies the signals to an image signal processor 614. The image signal processor 614 performs, under the control of a controller 621, prescribed image processing on the image signals supplied from the camera signal processor 613 and encodes the image signals according to, for example, an MPEG standard by means of an encoder 641. The image signal processor 614 supplies to a decoder 615 the encoded data generated by encoding the image signals. Further, the image signal processor 614 obtains displaying data generated at an on screen display (OSD) 620 and supplies the data to the decoder 615.

In the above-described processing, the camera signal processor 613 appropriately uses a DRAM (Dynamic Random Access Memory) 618 connected through a bus 617 and causes the DRAM 618 to retain image data and the encoded data obtained by encoding the image data, and other data, as needed.

The decoder 615 decodes the encoded data supplied from the image signal processor 614 and supplies the resultant image data (decoded image data) to the LCD 616. The decoder 615 also supplies displaying data supplied from the image signal processor 614 to the LCD 616. The LCD 616 suitably synthesizes the images of the decoded image data supplied from the decoder 615 with the displaying data, so as to display the synthesized data.

The on screen display 620 outputs, under the control of the controller 621, outputs displaying data for, for example, menu screens and icons containing symbols, characters, or figures, through the bus 617 to the image signal processor 614.

The controller 621 executes various kinds of processing based on the signals indicating commands that the user gives by using an operator 622 and also executes control through the bus 617 over, for example, the image signal processor 614, the DRAM 618, an external interface 619, the on screen display 620, and a media drive 623. Stored on the FLASH ROM 624 are, for example, programs and data to be used to enable the controller 621 to execute various kinds of processing.

For example, the controller 621 may, instead of the image signal processor 614 and the decoder 615, encode the image data stored on the DRAM 618 and decode the encoded data stored on the DRAM 618. In so doing, the controller 621 may perform encoding/decoding processing according to the same standard as the coding and decoding standard adopted by the image signal processor 614 and the decoder 615, or alternatively, may perform encoding/decoding processing according to a standard that is not supported by the image signal processor 614 and the decoder 615.

Further, for example, in the case where start of image printing is instructed by means of the operator 622, the controller 621 reads relevant image data from the DRAM 618 and supplies the data through the bus 617 to a printer 634 to be connected to the external interface 619 for printing.

Moreover, for example, in the case where image recording is instructed by means of the operator 622, the controller 621 reads relevant encoded data from the DRAM 618 and supplies the data through the bus 617 to a recording medium 633 to be loaded to the media drive 623.

The recording medium 633 is a readable and writable removable medium such as a magnetic disk, a magnetoptical disk, an optical disk, or a semiconductor memory. The recording medium 633 may obviously of any types of removable media; for example, the recording medium 633 may be a tape device, a disk, or a memory card. Apparently, a non-contact IC card may also be included in the types.

Furthermore, the media drive 623 and the recording medium 633 may be integrated, so as to be configured into a non-portable recording medium such as a built-in hard disk drive or an SSD (Solid State Drive).

The external interface 619 may be configured, for example, by a USB Input/Output terminal and is to be connected to the printer 634 for printing images. A drive 631 is to be connected to the external interface 619 as needed, to be appropriately loaded with a removable medium 632 such as a magnetic disk, an optical disk, or a magnetoptical disk, such that computer programs read therefrom are installed on the FLASH ROM 624 as needed.

The external interface 619 further includes a network interface to be connected to a prescribed network such as a LAN or the Internet. For example, the controller 621 is configured to read, in response to an instruction from the operator 622, encoded data from the DRAM 618, so as to supply the data through the external interface 619 to another apparatus to be connected thereto via the network. The controller 621 may also obtain encoded data and image data to be supplied from another apparatus over the network through the external interface 619, so as to cause the DRAM 618 to retain the data or to supply the data to the image signal processor 614.

The above-described camera 600 uses the image decoding apparatus 101 in the form of the decoder 615. Hence, the decoder 615 achieves, as in the case of the image decoding apparatus 101, improvement in prediction efficiency in weighted prediction for chrominance signals.

Hence, the camera 600 is capable of generating more precise prediction images. As a result, the camera 600 is capable of obtaining finer decoded images from, for example, image data generated at the CCD/CMOS 612, the encoded data of video data read from the DRAM 618 or the recording medium 633, and the encoded data of video data obtained over networks, for display on the LCD 616.

The camera 600 uses the image coding apparatus 51 in the form of the encoder 641. Hence, the encoder 641 achieves, as in the case of the image coding apparatus 51, improvement in prediction efficiency in weighted prediction for chrominance signals.

Accordingly, the camera 600 achieves improvement in coding efficiency of encoded data to be recorded, for example, on hard disks. As a result, the camera 600 is allowed for use of storage areas in the DRAM 618 and the recording medium 633 at a higher rate and efficiency.

It is to be noted that a decoding method of the image decoding apparatus 101 is applicable to the decoding processing to be performed by the controller 621. Likewise, an encoding method of the image coding apparatus 51 is applicable to the encoding processing to be performed by the controller 621.

Further, image data to be photographed by the camera 600 may be either moving images or still images.

Apparently, the image coding apparatus 51 and the image decoding apparatus 101 are applicable to apparatuses and systems other than those described above.

### REFERENCE SIGNS LIST

51 Image coding apparatus
66 Lossless encoder
74 Intra predictor
75 Motion predictor/compensator
76 Weighted predictor
81 Motion Searcher
82 Motion compensator
83 Cost function calculator
84 Mode determiner
91 Color format distinguisher
92 Weighted prediction controller
93 Color component discerner
94 Luminance weight/offset calculator
95 Chrominance weight/offset calculator
96 Luminance weighted motion compensator
97 Chrominance weighted motion compensator
101 Image decoding apparatus
112 Lossless decoder
121 Intra predictor
122 Motion compensator
123 Weighted predictor
131 Weighted prediction flag buffer
132 Prediction mode/motion vector buffer
133 Motion compensator
141 Weight/offset buffer
142 Weight factor calculator
143 Luminance weighted motion compensator
144 Chrominance weighted motion compensator

1. An image processing apparatus, comprising:
motion search means for searching a motion vector for a block to be encoded in an image; and
weighted prediction means for, in case where the image has a color format of YCbCr format, using a reference image pixel value referred to by the motion vector to be found through the search by the motion search means and performing weighted prediction differently on a chrominance component than on a luminance component.

2. The image processing apparatus according to claim 1, further comprising factor calculation means for calculating a weight factor and an offset for the chrominance component in case where the color format of the image is YCbCr format, wherein
the weighted prediction means is configured to use the weight factor and the offset to be calculated by the factor calculation means and the reference image pixel value to perform weighted prediction differently on the chrominance component than on the luminance component.

3. The image processing apparatus according to claim 2, wherein the weighted prediction means is configured to perform weighted prediction on the chrominance component according to the input bit accuracy and picture type of the image.

4. The image processing apparatus according to claim 3, wherein, in case of a P picture, the weighted prediction means is configured to perform weighted prediction representable by
W₀*(Y₀−2ⁿ⁻¹)+D+2ⁿ⁻¹
where, with the input being a video represented in n bit, Y₀ is the reference image pixel value, and W₀ and D are the weight factor and the offset for the weighted prediction, respectively, with respect to the chrominance component.

5. The image processing apparatus according to claim 3, wherein, in case of a B picture, the weighted prediction means is configured to perform weighted prediction representable by
W₀*(Y₀−2ⁿ⁻¹)+W₁*(Y₁−2ⁿ⁻¹)D+2ⁿ⁻¹
where, with the input being a video represented in n bit, Y₀ and Y₁ are the reference image pixel values in List0 and List1, respectively, and W₀, W₁, and D are the weight factors for List0 and List1 and the offset for the weighted prediction, respectively, with respect to the chrominance component.

6. The image processing apparatus according to claim 3, wherein, in case where the color format of the image is RGB format, the reference image pixel value is for use in performing the same weighted prediction on the chrominance component as that to be performed on the luminance component.

7. A method of processing images for use in an image processing apparatus including motion search means and weighted prediction means, the method comprising:
performing by the motion search means of the image processing apparatus search for a motion vector for a block to be encoded in an image; and
performing by the weighted prediction means of the image processing apparatus, in case where the image has a color format of YCbCr format, weighted prediction on a chrominance component differently than on a luminance component by using a reference image pixel value referred to by the motion vector found through the search.

8. An image processing apparatus, comprising:
decoding means for decoding a motion vector for a block to be decoded in an encoded image; and
weighted prediction means for using, in case where the image has a color format of YCbCr format, a reference image pixel value referred to by the motion vector to be decoded by the decoding means and performing weighted prediction on a chrominance component differently than on a luminance component.

9. The image processing apparatus according to claim 8, wherein the weighted prediction means is configured to perform weighted prediction on the chrominance component according to the input bit accuracy and picture type of the image.

10. The image processing apparatus according to claim 9, wherein, in case of a P picture, the weighted prediction means is configured to perform weighted prediction representable by
W₀*(Y₀−2ⁿ⁻¹)+D+2ⁿ⁻¹
where, with the input being a video represented in n bit, Y₀ is the reference image pixel value, and W₀ and D are the weight factor and the offset for the weighted prediction, respectively, with respect to the chrominance component.

11. The image processing apparatus according to claim 9, wherein, in case of a B picture, the weighted prediction means is configured to perform weighted prediction representable by
W₀*(Y₀−2ⁿ⁻¹)+W₁*(Y₁−2ⁿ⁻¹)D+2ⁿ⁻¹
where, with the input being a video represented in n bit, Y₀ and Y₁ are the reference image pixel values in List0 and List1, respectively, and W₀, W₁, and D are the weight factors for List0 and List1 and the offset for the weighted prediction, respectively, with respect to the chrominance component.

12. The image processing apparatus according to claim 9, further comprising factor calculation means for calculating a weight factor for the chrominance component in case where the color format of the image is YCbCr format, wherein
the weighted prediction means is configured to use the weight factor to be calculated by the factor calculation means and the reference image pixel value to perform weighted prediction differently on the chrominance component than on the luminance component.

13. The image processing apparatus according to claim 9, wherein, in case where the color format of the image is YCbCr format, the decoding means is configured to decode the weight factor and the offset for the chrominance component, and
the weighted prediction means is configured to use the weight factor and the offset to be decoded by the decoding means and the reference image pixel value to perform weighted prediction on the chrominance component differently than on the luminance component.

14. The image processing apparatus according to claim 9, wherein, in case where the color format of the image is RGB format, the reference image pixel value is for use in performing the same weighted prediction on the chrominance component as that to be performed on the luminance component.

15. An image processing apparatus, comprising:
decoding means of the image processing apparatus for decoding a motion vector for a block to be decoded in an encoded image; and
weighted prediction means of the image processing apparatus for, in case where the image has a color format of YCbCr format, using a reference image pixel value referred to by the decoded motion vector to perform weighted prediction on a chrominance component differently than on a luminance component.
